(19) United States
(12) Patent Application Publication
(10) Pub. No.: US 2026/0329691 A1
(43) Pub. Date: Oct. 22, 2026

(54) DISASTER RECOVERY FOR DISTRIBUTED COMPUTING SYSTEMS

(71) Applicant: NETAPP, INC., San Jose, CA (US)

(72) Inventors: Jayakrishnan Ramakrishna Pillai, Tracy, CA (US); Sachin Gandhi, Fremont, CA (US); Nishant Joshi, Bangalore (IN); Venkat Thangella, Bangalore (IN); Abhishek HS, Bangalore (IN); Rajaram Balakrishnan, Fremont, CA (US); Vineeth Karinta, Apex, NC (US); Rohit Kapoor, Redmond, WA (US)

(21) Appl. No.: 19/466,084

(22) Filed: Jan. 30, 2026

Related U.S. Application Data
(60) Provisional application No. 63/752,539, filed on Jan. 31, 2025.
(60) Provisional application No. 63/878,286, filed on Sep. 9, 2025.

(51) Int. Cl. G06F 11/07

(52) U.S. Cl. CPC G06F 11/0793; G06F 11/0715

(57) ABSTRACT

Methods and systems involve creating a disaster recovery plan using at least one storage resource discovered in the source environment, which includes establishing a storage replication relationship for a storage resource in the source environment when no storage replication relationship is found for the storage resource. Based on a selected disaster recovery plan, a disaster recovery operation is executed, which includes breaking an existing storage replication relationship associated with the disaster recovery plan and establishing a new storage replication relationship to complete the disaster recovery operation.

### CROSS-REFERENCE TO RELATED APPLICATIONS

This application claims priority under 35 USC § 119(e) to U.S. Provisional Application, Ser. No. 63/752,539, filed on Jan. 31, 2025, and U.S. Provisional Application, Ser. No. 63/878,286, filed on Sep. 9, 2025, the disclosures of which are incorporated herein by reference in their entirety.

### TECHNICAL FIELD

The present disclosure relates to distributed computing systems, and more particularly to disaster recovery in distributed computing systems.

### BACKGROUND

Distributed computing systems are widely used to support applications and data across multiple computing environments. Such distributed computing systems may include on-premises computing systems, public cloud computing systems, or combinations thereof, and may employ virtualized computing resources in which physical hardware is shared among multiple independently operating virtual machines.

As reliance on distributed computing systems has increased, the ability to recover applications and data from disruptive events has become increasingly important. Distributed computing systems remain vulnerable to hardware failures, outages, cyberattacks and natural disasters, regardless of whether the systems are deployed on-premises, in public cloud environments, or across a combination of both. Accordingly, disaster recovery plays an important role in maintaining availability and continuity of operations within the distributed computing systems.

Disaster recovery in distributed computing systems presents challenges due to differences in architecture, management and operational characteristics among different computing environments. These challenges may arise when disaster recovery is performed between on-premises computing systems, between public cloud computing systems, or between on-premises computing systems and public cloud computing systems. The rapid evolution and introduction of new cloud services further complicates integration and recovery across such environments.

### SUMMARY

Methods and systems involve creating a disaster recovery plan using at least one storage resource discovered in the source environment, which includes establishing a storage replication relationship for a storage resource in the source environment when no storage replication relationship is found for the storage resource. Based on a selected disaster recovery plan, a disaster recovery operation is executed, which includes breaking an existing storage replication relationship associated with the disaster recovery plan and establishing a new storage replication relationship to complete the disaster recovery operation.

A method executed by one or more processors in accordance with an embodiment of the invention comprises discovering, using a connector deployed within a source environment, at least one storage resource in the source environment, creating, by a disaster recovery service, a disaster recovery plan using the at least one storage resource discovered in the source environment, including establishing a storage replication relationship for a storage resource in the source environment when no storage replication relationship is found for the storage resource, saving the disaster recovery plan to a list of disaster recovery plans maintained by the disaster recovery service, selecting a disaster recovery plan for execution from the list of disaster recovery plans, and executing a disaster recovery operation based on the selected disaster recovery plan, including breaking an existing storage replication relationship associated with the disaster recovery plan and establishing a new storage replication relationship to complete the disaster recovery operation. In some embodiments, the steps of this method are performed when program instructions contained in a non-transitory computer-readable storage medium are executed by one or more processors.

A system in accordance with an embodiment of the invention comprises memory and at least one processor configured to discover, using a connector deployed within a source environment, at least one storage resource in the source environment, create a disaster recovery plan using the at least one storage resource discovered in the source environment, including establishing a storage replication relationship for a storage resource in the source environment when no storage replication relationship is found for the storage resource, save the disaster recovery plan to a list of disaster recovery plans, select a disaster recovery plan for execution from the list of disaster recovery plans, and execute a disaster recovery operation based on the selected disaster recovery plan, including breaking an existing storage replication relationship associated with the disaster recovery plan and establishing a new storage replication relationship to complete the disaster recovery operation.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

The foregoing features and other features will now be described with reference to the drawings of the various aspects of the present disclosure. In the drawings, the same components have the same reference numerals, and similar reference numbers may be used to identify similar elements. The illustrated aspects are intended to illustrate, but not to limit the present disclosure. The drawings include the following figures.

FIG. 1 shows a distributed computing environment that includes a primary site, a number of secondary sites and a cloud-based disaster recovery service in which embodiments of the disclosure may be implemented.

FIG. 2 shows an on-premises (on-prem) computing system, which can be a primary or secondary site, in accordance with an embodiment of the disclosure.

FIG. 3 shows a storage system of the on-prem computing system in accordance with an embodiment of the disclosure.

FIG. 4 shows components of a node computing device in the storage system of FIG. 3 in accordance with an embodiment of the disclosure.

FIG. 5 shows a computing environment of the on-prem computing environment in accordance with an embodiment of the disclosure.

FIG. 6 shows a disaster recovery system in the distributed computing system formed by the primary site and one of the secondary sites in which the primary site is an on-prem computing system and the secondary site is another on-prem computing system in accordance with an embodiment of the disclosure.

FIG. 7 shows a flow diagram of a process of creating a disaster recovery plan between the primary on-prem computing system and the secondary on-prem computing system in accordance with an embodiment of the disclosure.

FIG. 8 shows a flow diagram of a process of executing a test failover from the primary on-prem computing system to the secondary on-prem computing system in accordance with an embodiment of the disclosure.

FIG. 9 shows a flow diagram of a process of executing a failover from the primary on-prem computing system to the secondary on-prem computing system in accordance with an embodiment of the disclosure.

FIG. 10 shows a flow diagram of a process of executing a failback from the secondary on-prem computing system to the primary on-prem computing system in accordance with an embodiment of the disclosure.

FIG. 11 shows a disaster recovery system in the distributed computing system formed by the primary site and one of the secondary sites in which the primary site is an on-prem computing system and the secondary site is an Elastic VMware Service (EVS) with Amazon FSx for NetApp ONTAP (FSxN) cloud service running in accordance with an embodiment of the disclosure.

FIG. 12 shows a flow diagram of a process of creating a disaster recovery plan between the on-prem computing system and the EVS with FSxN cloud service in accordance with an embodiment of the disclosure.

FIG. 13 shows a flow diagram of a process of executing a test failover from the on-prem computing system to the EVS with FSxN cloud service in accordance with an embodiment of the disclosure.

FIG. 14 shows a flow diagram of a process of executing a failover from the on-prem computing system to the EVS with FSxN cloud service in accordance with an embodiment of the disclosure.

FIG. 15 shows a flow diagram of a process of executing a failback from the EVS with FSxN cloud service to the on-prem computing system in accordance with an embodiment of the disclosure.

FIG. 16 shows a disaster recovery system in the distributed computing system formed by the primary site and one of the secondary sites in which the primary site is an on-prem computing system and the secondary site is a VMware Cloud on AWS (VMC on AWS) with FSxN cloud service in accordance with an embodiment of the disclosure.

FIG. 17 shows a flow diagram of a process of creating a disaster recovery plan between the on-prem computing system and the VMC on AWS with FSxN cloud service in accordance with an embodiment of the disclosure.

FIG. 18 shows a flow diagram of a process of executing a test failover from the on-prem computing system to the VMC on AWS with FSxN cloud service in accordance with an embodiment of the disclosure.

FIG. 19 shows a flow diagram of a process of executing a failover from the on-prem computing system to the VMC on AWS with FSxN cloud service in accordance with an embodiment of the disclosure.

FIG. 20 shows a flow diagram of a process of executing a failback from the VMC on AWS with FSxN cloud service to the on-prem computing system in accordance with an embodiment of the disclosure.

FIG. 21 shows a disaster recovery system in the distributed computing system 100 formed by the primary site and one of the secondary sites in which the primary site is an on-prem computing system and the secondary site is an Azure VMware Solution (AVS) with Cloud Volumes ONTAP (CVO) cloud service in accordance with an embodiment of the disclosure.

FIG. 22 shows a flow diagram of a process of creating a disaster recovery plan between the on-prem computing system and the AVS with CVO cloud service in accordance with an embodiment of the disclosure.

FIG. 23 shows a flow diagram of a process of executing a test failover from the on-prem computing system to the AVS with CVO cloud service in accordance with an embodiment of the disclosure.

FIG. 24 shows a flow diagram of a process of executing a failover from the on-prem computing system to the AVS with CVO cloud service in accordance with an embodiment of the disclosure.

FIG. 25 shows a flow diagram of a process of executing a failback from the AVS with CVO cloud service to the on-prem computing system in accordance with an embodiment of the disclosure.

FIG. 26 shows a disaster recovery system in the distributed computing system formed by the primary site and one of the secondary sites in which the primary site is an on-prem computing system and the secondary site is an AVS with Azure NetApp Files (ANF) cloud service in accordance with an embodiment of the disclosure.

FIGS. 27A and 27B show a flow diagram of a process of migrating VMs from the on-prem computing system to the AVS with ANF cloud service in accordance with an embodiment of the disclosure.

FIG. 28 shows a cloud-to-cloud disaster recovery system in the distributed computing system formed by the primary site and one of the secondary sites in which the primary site is a first AVS with ANF cloud service and the secondary site is a second AVS with ANF cloud service in accordance with an embodiment of the disclosure.

FIG. 29 shows a flow diagram of a process of creating a disaster recovery plan between the first AVS with ANF cloud service and the second AVS with ANF cloud service in accordance with an embodiment of the disclosure.

FIG. 30 shows a flow diagram of a process of executing a test failover from the first AVS with ANF cloud service to the second AVS with ANF cloud service in accordance with an embodiment of the disclosure.

FIG. 31 shows a flow diagram of a process of executing a failover from the first AVS with ANF cloud service to the second AVS with ANF cloud service in accordance with an embodiment of the disclosure.

FIG. 32 shows a flow diagram of a process of executing a failback from the second AVS with ANF cloud service to the first AVS with ANF cloud service in accordance with an embodiment of the disclosure.

FIG. 33 shows a multi-region deployment architecture for the cloud-based disaster recovery service in accordance with an embodiment of the disclosure.

FIG. 34 is a flow diagram of a method in accordance with an embodiment of the invention.

FIG. 35 is a high-level block diagram showing an example of the architecture of a processing system in accordance with an embodiment of the disclosure.

### DETAILED DESCRIPTION

As preliminary note, the terms “component”, “module”, “system,” and the like as used herein are intended to refer to a computer-related entity, either software-executing general-purpose processor, hardware, firmware and a combination thereof. For example, a component may be, but is not limited to being, a process running on a processor, a hardware-based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an application specific integrated circuit (ASIC), compact disc (CD), digital video disk (DVD), read only memory (ROM), solid state drive, hard disk, electrically erasable programmable read only memory (EEPROM), non-volatile memory or any other storage device, in accordance with the claimed subject matter.

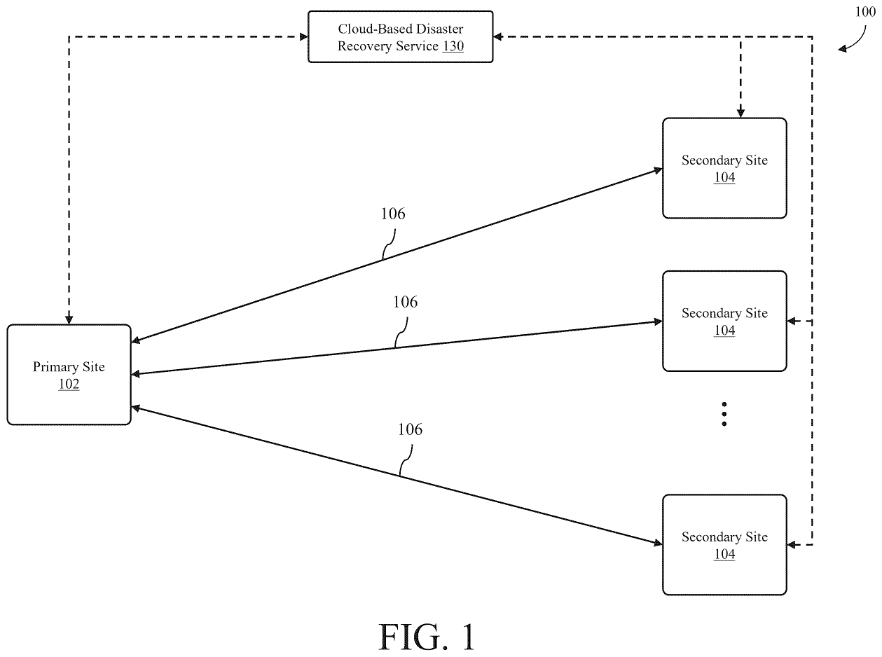

Turning now to FIG. 1, a distributed computing system 100 in which embodiments of the disclosure may be implemented is illustrated. The distributed computing system 100 includes a source site 102 and one or more secondary sites 104 that are communicatively connected by one or more connections 106. The source site 102 and each of the secondary sites 104 may independently be implemented as an on-premises computing system or a public cloud computing service, such as an Elastic VMware Service (EVS) with Amazon FSx for NetApp ONTAP (FSxN) cloud service, a VMware Cloud on AWS (VMC on AWS) with FSxN cloud service, an Azure VMware Solution (AVS) with Cloud Volumes ONTAP (CVO) cloud service or an AVS with Azure NetApp Files (ANF) cloud service. Each secondary site may serve as a recovery target for workloads and data associated with the source site 102. Thus, the distributed computing system 100 may support disaster recovery between on-premises computing systems, between public cloud computing services, and between an on-premises computing system and a public cloud computing service.

The connections 106 provide communication between the source site 102 and the secondary sites 104. Each connection may be implemented using one or more networking technologies suitable for enabling data transfer and communication between the respective sites. In addition, to the connections, one or more replication relationships may be established between the source site 102 and the secondary sites 104, which enable data associated with the source site to be replicated to a corresponding secondary site. In some embodiments, different replication mechanisms may be used for different secondary sites based on the storage technologies available for those sites.

The distributed computing system 100 further includes a cloud-based disaster recovery service 130 that operates to orchestrate disaster recovery operations between the source site 102 and the secondary sites 104. These operations may include, but not limited to, creating disaster recovery plan, creating backups and executing migrations, test failover, failover and failback, which are described in detail below. The cloud-based disaster recovery service 130 may be implemented in any computing system, e.g., a public cloud computing system, that may be separate from the source site 102 and the secondary sites 104.

The cloud-based disaster recovery service 130 communicates with one or more connectors (not shown in FIG. 1) that may be deployed at the source site 102 and/or the secondary sites 104. The connectors are configured to discover compute and storage resources at the respective sites and to provide the discovered information to the cloud-based disaster recovery service 130.

Based on the discovered resources, the cloud-based disaster recovery service 130 may create one or more disaster recovery (DP) plans that define how workloads and data associated with the source site 102 are to be protected and recovered at one or more secondary sites. In some embodiments, separate disaster recovery plans may be created for different secondary sites and may support recovery of workloads and data associated with the source site 102 to different secondary sites, which may involve distributing workloads across multiple secondary sites during a recovery operation. In some embodiments, the source site 102 and one or more of the secondary sites 104 may form a mesh topology in which any site may serve as a source site or a secondary site at different times, thereby enabling disaster recovery operations to be orchestrated in multiple directions.

In an embodiment, the cloud-based disaster recovery service 130 may operate to provide disaster recovery related functionalities as a Disaster Recovery as a Service (DRaaS) solution. In an embodiment, the cloud-based disaster recovery service 130 may provide disaster recovery related functionalities between the primary site 102 and more than one of the secondary sites 104, some of which may be deployed as hyperscaler cloud services. As an example, the cloud-based disaster recovery service 130 may provide disaster recovery related functionalities between the primary site 102 and a hyperscaler cloud service secondary site for some workloads or processes running on the primary site and between the primary site and another hyperscaler cloud service secondary site for other workloads or processes running on the primary site.

The distributed computing system 100 shown in FIG. 1 provides a high-level overview of a multi-site disaster recovery architecture. Specific recovery workflows and operational sequences that may be performed within the distributed computing system 100 are described below with reference to subsequent figures.

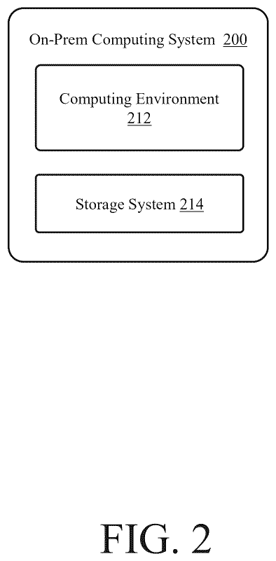

Turning now to FIG. 2, an on-premises (on-prem) computing system 200 in accordance with an embodiment of the disclosure is illustrated. The on-prem computing system 200 may be the primary site 102 in some embodiments or may be one of the secondary sites 104 in other embodiments.

As shown in FIG. 2, the on-prem computing system 200 includes a computing environment 212 and a storage system 214. The computing environment 212 is described herein as a VMware vSphere environment. However, the computing environment can be any virtualization computing environment that can support virtual machines (VMs). The storage system 214 provides storage resources for the computing environment 212. The storage system 214 is described herein as being a NetApp ONTAP storage system. However, in other embodiments, the storage system 214 may be another type of storage system. In the illustrated embodiment, the storage system 214 includes one storage cluster, such as an ONTAP cluster, as described below. However, in other embodiments, the storage system 214 may include multiple storage clusters. The computing environment 212 and the storage system 214 are further described below.

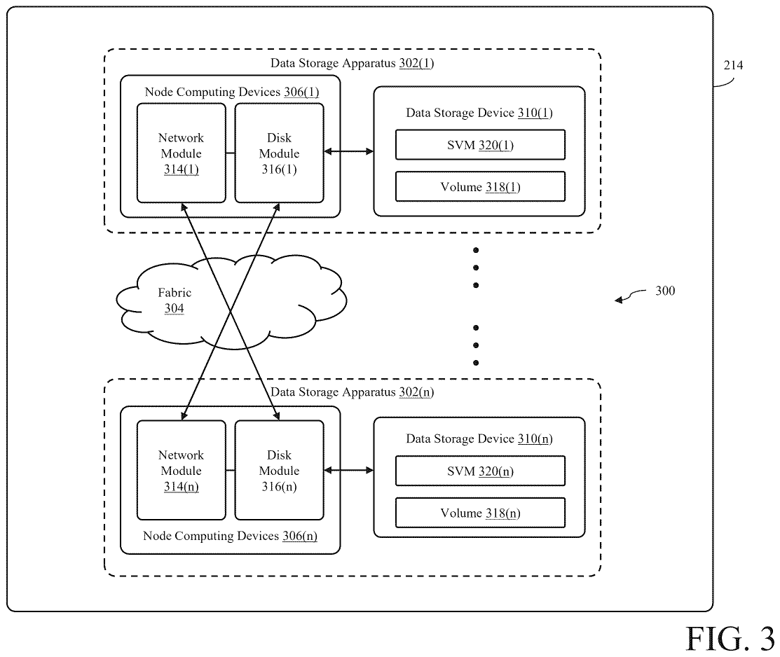

Turning now to FIG. 3, the storage system 214 of the on-prem computing system 200 in accordance with an embodiment of the disclosure is shown. The storage system 214 includes a cluster 300, which includes data storage apparatuses 302(1)-302(n) that are coupled over a cluster fabric 304 that includes communication network(s) and facilitates communication between the data storage apparatuses 302(1)-302(n) (and one or more modules, components, etc. therein, such as, node computing devices 306(1)-306(n), for example), although any number of other elements or components can also be included in the distributed computing system 100 in other examples.

The node computing devices 306(1)-306(n) can be local storage controllers that provide clients, such as entities, applications and/processes, including virtual machines (VMs), running in the computing environment 212 with access to data stored within data storage devices 310(1)-310(n). The data storage apparatuses 302(1)-302(n) and/or node computing devices 306(1)-306(n) of the examples described and illustrated herein are not limited to any particular geographic areas and can be clustered locally and/or remotely via a cloud network, or not clustered in other examples. Thus, in one example the data storage apparatuses 302(1)-302(n) and/or node computing device 306(1)-306(n) are distributed over a plurality of storage systems located in a plurality of geographic locations; while in another example a clustered network can include data storage apparatuses 302(1)-302(n) and/or node computing device 306(1)-306(n) residing in a same geographic location (e.g., in a single on-site rack).

The node computing devices 306(1)-306(n) can include various functional components that coordinate to provide a distributed storage architecture. For example, the node computing devices 306(1)-306(n) can include network modules 314(1)-314(n) and disk modules 316(1)-316(n). The network modules 314(1)-314(n) can be configured to allow the node computing devices 306(1)-306(n) (e.g., network storage controllers) to connect with client devices over storage network connections, for example, allowing the client devices to access data stored in the cluster 300.

Further, the network modules 314(1)-314(n) can provide connections with one or more other components through the cluster fabric 304. For example, the network module 314(1) of node computing device 306(1) can access the data storage device 310(n) by sending a request via the cluster fabric 304 through the disk module 316(n) of node computing device 306(n). The cluster fabric 304 can include one or more local and/or wide area computing networks (e.g., cloud networks) embodied as Infiniband, Fibre Channel (FC), or Ethernet networks, for example, although other types of networks supporting other protocols can also be used.

The disk modules 316(1)-316(n) can be configured to connect the data storage devices 310(1)-310(n), such as disks or arrays of disks, solid state drives (SSDs), flash memory, or another form of data storage, to the node computing devices 306(1)-306(n). Often, the disk modules 316(1)-316(n) communicate with the data storage devices 310(1)-310(n) according to the SAN protocol, such as SCSI or FCP, for example, although other protocols can also be used. Thus, as seen from an operating system on the node computing devices 306(1)-306(n), the data storage devices 310(1)-310(n) can appear as locally attached. In this manner, different node computing devices 306(1)-306(n), etc. may access data blocks, files, or objects through the operating system, rather than expressly requesting abstract files.

While the cluster 300 illustrates an equal number of network modules 314(1)-314(n) and disk modules 316(1)-316(n), other examples may include a differing number of these modules. For example, there may be a plurality of network and disk modules interconnected in a cluster that do not have a one-to-one correspondence between the network and disk modules. That is, different node computing devices can have a different number of network and disk modules, and the same node computing device can have a different number of network modules than disk modules.

In one example, the storage apparatuses 302(1)-302(n) host aggregates corresponding to physical local and remote data storage devices, such as local flash or disk storage in the data storage devices 310(1)-310(n), for example. One or more of the data storage devices 310(1)-310(n) can include mass storage devices, such as disks of a disk array. The disks may comprise any type of mass storage devices, including but not limited to, magnetic disk drives, flash memory, and any other similar media adapted to store information, including, for example, data and/or parity information.

The aggregates include volumes 318(1)-318(n) in this example, although any number of volumes can be included in the aggregates. The volumes 318(1)-318(n) are virtual data stores or storage objects that define an arrangement of storage and one or more file systems within the storage system 214. Volumes 318(1)-318(n) can span a portion of a disk or other storage device, a collection of disks, or portions of disks, for example, and typically define an overall logical arrangement of data storage. In one example volumes 318(1)-318(n) can include stored user data as one or more files, blocks, or objects that reside in a hierarchical directory structure within the volumes 318(1)-318(n).

The volumes 318(1)-318(n) are typically configured in formats that may be associated with particular storage systems, and respective volume formats typically comprise features that provide functionality to the volumes 318(1)-318(n), such as providing the ability for volumes 318(1)-318(n) to form clusters, among other functionality. Optionally, one or more of the volumes 318(1)-318(n) can be in composite aggregates and can extend between one or more of the data storage devices 310(1)-310(n) to provide tiered storage, for example, and other arrangements can also be used in other examples.

As an example, one or more of the data storage devices 310(1)-310(n) may be configured as a multi-tier storage architecture that includes a plurality of storage tiers that are logically and/or physically organized based on factors such as performance characteristics, cost, and data access frequency. Each storage tier may be configured to store a particular category of data according to operational importance and access requirements.

In an embodiment, to facilitate access to data stored on the disks or other structures of the data storage devices 310(1)-310(n), a file system may be implemented that logically organizes the information as a hierarchical (e.g., tree) structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage devices 310(1)-310(n) (e.g., a Redundant Array of Independent (or Inexpensive) Disks (RAID system)) whose address, addressable space, location, etc. does not change. Typically the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more logical unit numbers (LUNs), directories, Qtrees, files, and/or other storage objects, for example. Among other things, these features, but more particularly the LUNs, allow the disparate memory locations within which data is stored to be identified, for example, and grouped as a data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage devices 310(1)-310(n) can have one or more physical ports, wherein each physical port can be assigned a target address (e.g., SCSI target address). To represent respective volumes, a target address on the data storage devices 310(1)-310(n) can be used to identify one or more of the LUNs. Thus, for example, when one of the node computing devices 306(1)-306(n) connects to a volume, a connection between the one of the node computing devices 306(1)-306(n) and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

In certain embodiments, the cluster 300 may implement storage virtual machines (SVMs) 320(1)-320(n) as logical entities that abstract underlying physical and logical storage resources. An SVM may provide data access services to clients and may operate independently of other SVMs within the storage system 214. Each SVM may be configured with its own namespace, storage volumes, network interfaces, and security policies, thereby allowing for secure multi-tenancy and administrative isolation. An SVM may serve one or more of the volumes 318(1)-318(n), and consequently, an SVM may be considered to be the root of the directories it serves.

In an embodiment, the cluster 300 of the data storage apparatuses 302(1)-302(n) is an Open Network Technology for Appliance Products (ONTAP) cluster. Although the storage system 214 may include multiple ONTAP clusters, the storage system will be described herein as including one ONTAP cluster. In addition, in some embodiments, data for the VMs running in the computing environment 212 is stored in the ONTAP cluster 300.

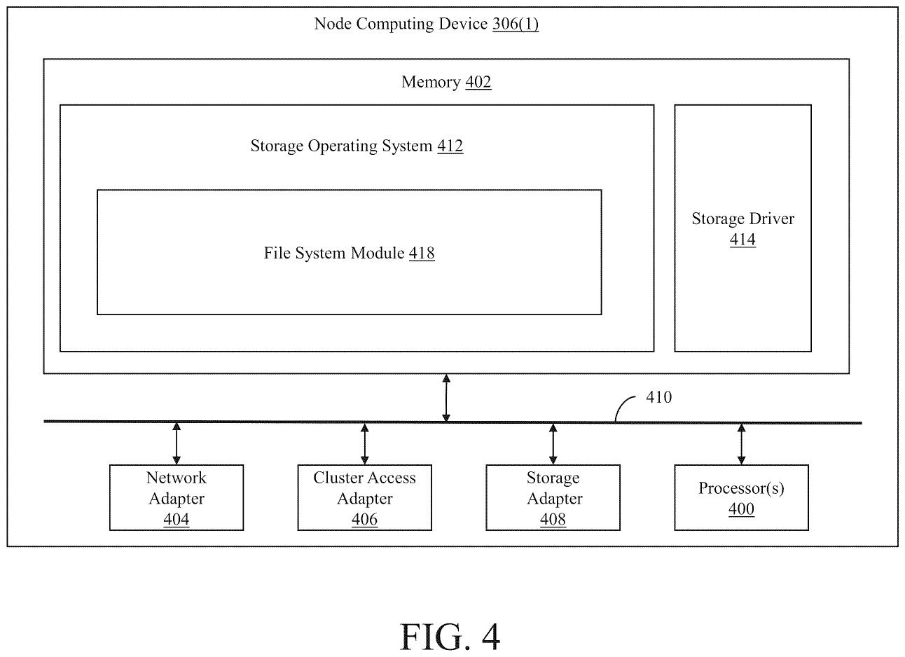

Referring now to FIG. 4, components of the node computing device 306(1) in accordance with an embodiment of the disclosure are shown. The node computing device 306(1) in this particular embodiment includes processor(s) 400, a memory 402, a network adapter 404, a cluster access adapter 406, and a storage adapter 408 interconnected by a system bus 410. The node computing device 306(1) also includes a storage operating system 412 installed in the memory 402 that can, for example, implement a RAID data loss protection and recovery scheme to optimize reconstruction of data of a failed disk or drive in an array. In some examples, the node computing device 306(n) is substantially the same in structure and/or operation as node computing device 306(1), although the node computing device 306(n) can also include a different structure and/or operation in one or more aspects than the node computing device 306(1).

The network adapter 404 in this example includes the mechanical, electrical and signaling circuitry needed to connect the node computing device 306(1) to one or more of the client devices running in the computing environment 212, which may comprise, among other things, a point-to-point connection or a shared medium, such as a LAN. In some examples, the network adapter 404 further communicates (e.g., using TCP/IP) via the cluster fabric 304 to process storage operations associated with data stored thereon.

The storage adapter 408 cooperates with the storage operating system 412 executing on the node computing device 306(1) to access information requested by one or more client devices (e.g., to access data on a data storage device 310(1)-310(n) managed by a network storage controller). The information may be stored on any type of attached array of writeable media such as magnetic disk drives, flash memory, and/or any other similar media adapted to store information.

In the exemplary data storage devices 310(1)-310(n), information can be stored in data blocks on disks. The storage adapter 408 can include I/O interface circuitry that couples to the disks over an I/O interconnect arrangement, such as a SAN protocol. The information is retrieved by the storage adapter 408 and, if necessary, processed by the processor(s) 400 (or the storage adapter 408 itself) prior to being forwarded over the system bus 410 to the network adapter 404 (and/or the cluster access adapter 406 if sending to another node computing device in the cluster) where the information is formatted into a data packet and returned to a requesting client device and/or sent to another node computing device attached via the cluster fabric 304. In some examples, a storage driver 414 in the memory 402 interfaces with the storage adapter 408 to facilitate interactions with the data storage devices 310(1)-310(n).

The storage operating system 412 can also manage communications for the node computing device 306(1) among other devices that may be in a clustered network, such as devices attached to the cluster fabric 304. Thus, the node computing device 306(1) can respond to client device requests to manage data on one of the data storage devices 310(1)-310(n) (e.g., or additional clustered devices) in accordance with the client device requests.

The storage operating system 412 includes a file system module 418, which can establish and manage one or more file systems including software code and data structures that implement a persistent hierarchical namespace of files and directories, for example. As an example, when a new data storage device (not shown) is added to a clustered network system, the file system module 418 is informed where, in an existing directory tree, new files associated with the new data storage device are to be stored. This is often referred to as “mounting” a file system.

In an embodiment, the memory 402 can include storage locations that are addressable by the processor(s) 400 and the adapters 404, 406, and 408 for storing related software application code and data structures. The processor(s) 400 and the adapters 404, 406, and 408 may, for example, include processing elements and/or logic circuitry configured to execute the software code and manipulate the data structures.

The storage operating system 412, portions of which are typically resident in the memory 402 and executed by the processor(s) 400, invokes storage operations in support of a file service implemented by the node computing device 306(1). Other processing and memory mechanisms, including various computer readable media, may be used for storing and/or executing application instructions pertaining to the techniques described and illustrated herein.

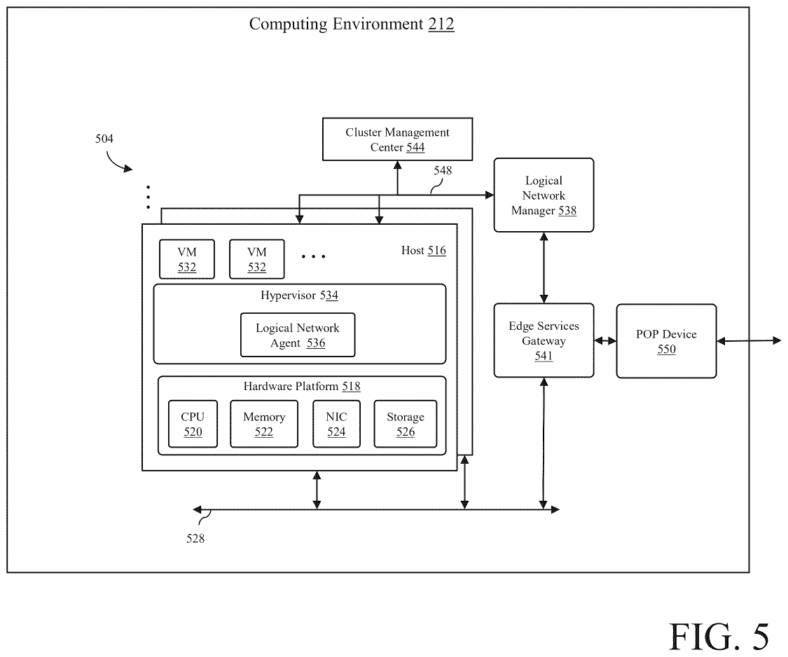

Turning now to FIG. 5, the computing environment 212 of the on-prem computing environment 102 in accordance with an embodiment of the disclosure is illustrated. As shown in FIG. 5, the computing environment 212 includes a cluster 504 of host computers (“hosts”) 516. The hosts 516 may be constructed on a server grade hardware platform 518, such as an x86 architecture platform. As shown, the hardware platform 518 of each host 516 may include conventional components of a computer, such as one or more processors (e.g., CPUs) 520, system memory 522, a network interface 524, and storage 526. The processor 520 can be any type of a processor commonly used in servers. In some embodiments, the memory 522 is volatile memory used for retrieving programs and processing data. The memory 522 may include, for example, one or more random access memory (RAM) modules. The network interface 524 enables the host 516 to communicate with other devices that are inside or outside of the computing environment 212 via a communication network, such as a network 528. The network interface 524 may be one or more network adapters, also referred to as network interface cards (NICs). The storage 526 represents one or more local storage devices (e.g., one or more hard disks, flash memory modules, solid state disks and/or optical disks).

Each host 516 may be configured to provide a virtualization layer that abstracts processor, memory, storage and networking resources of the hardware platform 518 into virtual computing instances (VCIs) 532 that run concurrently on the same host. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the disclosure described herein are not limited to virtual machines (VMs).

In the illustrated embodiment, the VCIs in the form of VMs 532 are provided by host virtualization software 534, which is referred to herein as a hypervisor, which enables sharing of the hardware resources of the host by the VMs. One example of the hypervisor 534 that may be used in an embodiment described herein is a VMware ESXi™ hypervisor provided as part of the VMware vSphere® solution made commercially available from VMware, Inc. The hypervisor 534 may run on top of the operating system of the host or directly on hardware components of the host. For other types of VCIs, the host may include other virtualization software platforms to support those VCIs, such as Docker virtualization platform to support “containers”. Although embodiments of the disclosures may involve other types of VCIs, various embodiments of the disclosure are described herein as involving VMs.

In the illustrated embodiment, the hypervisor 534 includes a logical network (LN) agent 536, which operates to provide logical networking capabilities, also referred to as “software-defined networking”. Each logical network may include software managed and implemented network services, such as bridging, L3 routing, L2 switching, network address translation (NAT), and firewall capabilities, to support one or more logical overlay networks in the computing environment 212. The logical network agent 536 may receive configuration information from a logical network manager 538 (which may include a control plane cluster) and, based on this information, populates forwarding, firewall and/or other action tables for dropping or directing packets between the VMs 532 in the host 516, other VMs on other hosts, and/or other devices outside of the computing environment 212. Collectively, the logical network agent 536, together with other logical network agents on other hosts, according to their forwarding/routing tables, implement isolated overlay networks that can connect arbitrarily selected VMs with each other. Each VM may be arbitrarily assigned a particular logical network in a manner that decouples the overlay network topology from the underlying physical network. Generally, this is achieved by encapsulating packets at a source host and decapsulating packets at a destination host so that VMs on the source and destination can communicate without regard to the underlying physical network topology. In a particular implementation, the logical network agent 536 may include a Virtual Extensible Local Area Network (VXLAN) Tunnel End Point or VTEP that operates to execute operations with respect to encapsulation and decapsulation of packets to support a VXLAN backed overlay network. In alternate implementations, VTEPs support other tunneling protocols, such as stateless transport tunneling (STT), Network Virtualization using Generic Routing Encapsulation (NVGRE), or Geneve, instead of, or in addition to, VXLAN.

The hypervisor 534 may also include a local scheduler and a high availability (HA) agent, which are not illustrated. The local scheduler operates as a part of a resource scheduling system that provides load balancing among enabled hosts 516 in the cluster 504. The HA agent operates as a part of a high availability system that provides high availability of select VMs running on the hosts 516 in the cluster 504 by monitoring the hosts, and in the event of a host failure, the VMs on the failed host are restarted on alternate hosts in the cluster.

As noted above, the computing environment 212 also includes the logical network manager 538 (which may include a control plane cluster), which operates with the logical network agents 536 in the hosts 516 to manage and control logical overlay networks in the SDDC. In some embodiments, the computing environment 212 include multiple logical network managers that provide the logical overlay networks of the computing environment. Logical overlay networks comprise logical network devices and connections that are mapped to physical networking resources, e.g., switches and routers, in a manner analogous to the manner in which other physical resources as compute and storage are virtualized. In an embodiment, the logical network manager 538 has access to information regarding physical components and logical overlay network components in the computing environment 212. With the physical and logical overlay network information, the logical network manager 538 is able to map logical network configurations to the physical network components that convey, route, and filter physical traffic in the computing environment. In a particular implementation, the logical network manager 538 is a VMware NSX® Manager™ product running on any computer, such as one of the hosts 516 or VMs 532 in the computing environment.

The computing environment 212 also includes one or more edge services gateway 541, which may be connected to a point of presence (POP) device 550, to control network traffic into and out of the computing environment. In a particular implementation, the edge services gateway 541 is VMware NSX® Edge™ product made available from VMware, Inc. running on any computer, such as one of the hosts 516 or VMs 532 in the computing environment. The logical network manager(s) 538 and the edge services gateway(s) 541 are part of a logical network platform, which supports the software-defined networking in the computing environment.

The computing environment 212 also includes the cluster management center 544, which operates to manage and monitor the cluster 504 of hosts 516. The cluster management center 544 may be configured to allow an administrator to create a cluster of hosts, add hosts to the cluster, delete hosts from the cluster and delete the cluster. The cluster management center 544 may further be configured to monitor the current configurations of the hosts 516 in the cluster 504 and the VMs running on the hosts. The monitored configurations may include hardware and/or software configurations of each of the hosts 516. The monitored configurations may also include VM hosting information, i.e., which VMs are hosted or running on which hosts. In order to manage the hosts 516 and the VMs 532 in the cluster, the cluster management center 544 supports or executes various operations. As an example, the cluster management center 544 may be configured to perform resource management operations for the cluster 504, including VM placement operations for initial placement of VMs and load balancing.

In an embodiment, the cluster management center 544 is a computer program that resides and executes in a computer system, such as one of the hosts 516, or in one of the VMs 532 running on the hosts 516. One example of the cluster management center 544 is the VMware vCenter Server® product made available from VMware, Inc. Thus, the cluster management center 544 may be referred to herein as a vCenter module.

In the illustrated embodiment, the management components of the computing environment 212, such as the logical network manager 538, the edge services gateway 541, and the cluster management center 544, communicate using a management network 548, which may be separate from the network 528, which are used by the hosts 516 and the VMs 532 on the hosts. In an embodiment, at least some of the management components or entities of the computing environment may be implemented in one or more virtual computing instance, e.g., VMs 532, running in the computing environment. In some embodiments, there may be multiple instances of the logical network manager 538 and the edge services gateway 541 that are deployed in multiple VMs running in the computing environment.

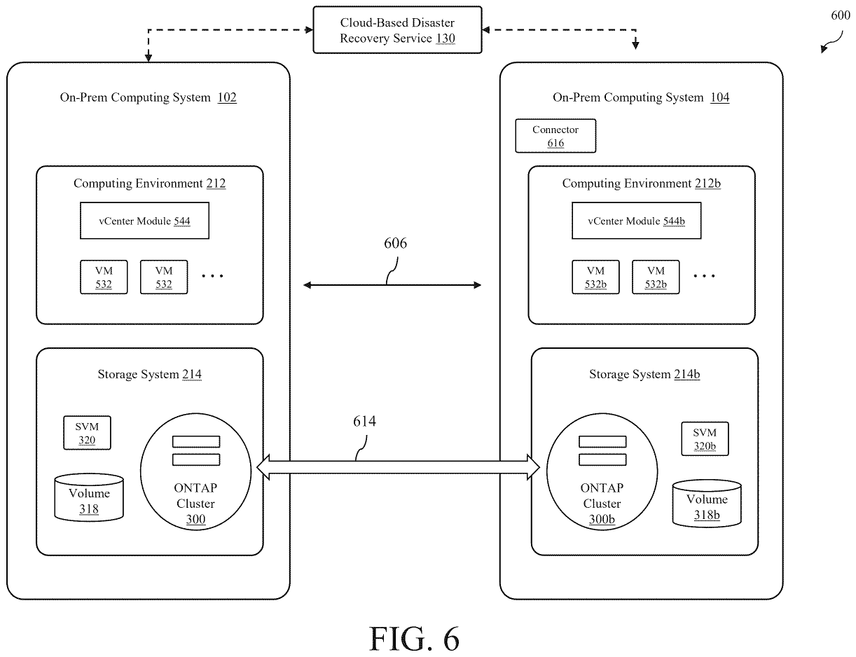

Turning now to FIG. 6, a disaster recovery system 600 in the distributed computing system 100 formed by the primary site 102 and a secondary site 104-1 of the secondary sites 104 in which the primary site 102 is an on-prem computing system and the secondary site 104-1 is another on-prem computing system in accordance with an embodiment of the disclosure is shown. The primary on-prem computing system 102 and the secondary on-prem computing system 104-1 may be located in different geographic locations, such as different datacenters, different buildings, or different regions. The primary on-prem computing system 102 may be used as a protected site and the secondary on-prem computing system 104-1 may be used as a backup site, or vice versa.

In FIG. 6, the primary on-prem computing system 102 includes the computing environment 212 and the storage system 214. The computing environment 212 is shown with only the cluster management center 544 in the form of a vCenter module and the VMs 532. In addition, the storage system 214 of the on-prem computing system 102 is shown with only the ONTAP cluster 300, a representative volume 318 and a representative SVM 320. Similarly, the secondary on-prem computing system 104-1 includes a computing environment 212b and a storage system 214b. Similar to the primary on-prem computing system 102, the computing environment 212b of the secondary on-prem computing system 104-1 is shown only with a vCenter module 544b and VMs 532b. The storage system 214b of the secondary on-prem computing system 104-1 is shown with only an ONTAP cluster 300b, a representative volume 318b and a representative SVM 320b.

A connection 606 provides communication between the primary on-prem computing system 102 and the secondary on-prem computing system 104-1. The connection 606 may be implemented as a dedicated network connection, a virtual private network (VPN), or another type of network connection that enables communication between the two on-prem computing systems.

The ONTAP cluster 300b in the secondary on-prem computing system 104-1 may establish a SnapMirror relationship 614 with the ONTAP cluster 300 in the primary on-prem computing system 102. The SnapMirror relationship 614 may be a replication connection from the primary on-prem ONTAP cluster 300 to the secondary on-prem ONTAP cluster 300b or vice versa. As used herein, a SnapMirror replication is a snapshot-based data replication mechanism that establishes a replication relationship between a source storage volume and a destination storage volume, in which an initial point-in-time snapshot of the source storage volume is used to create a baseline copy at the destination storage volume and subsequent snapshots are used to identify and incrementally transfer data changes to maintain an up-to-date replica for disaster recovery and high availability purposes. A Snapmirror relationship is a replication relationship that uses a SnapMirror replication.

In this embodiment, the cloud-based disaster recovery service 130 operates to orchestrate disaster recovery operations between the primary on-prem computing system 102 and the secondary on-prem computing system 104-1 using a connector 616, which can be deployed in the secondary on-prem computing system 104-1, as illustrated in FIG. 6, or deployed in the primary on-prem computing system 102. As described below, the connector is used to discover compute and storage details of the primary on-prem computing system 102 and the secondary on-prem computing system 104-1. After the discovery, various disaster recovery operations, such as test failover, failover and failback processes, can be performed.

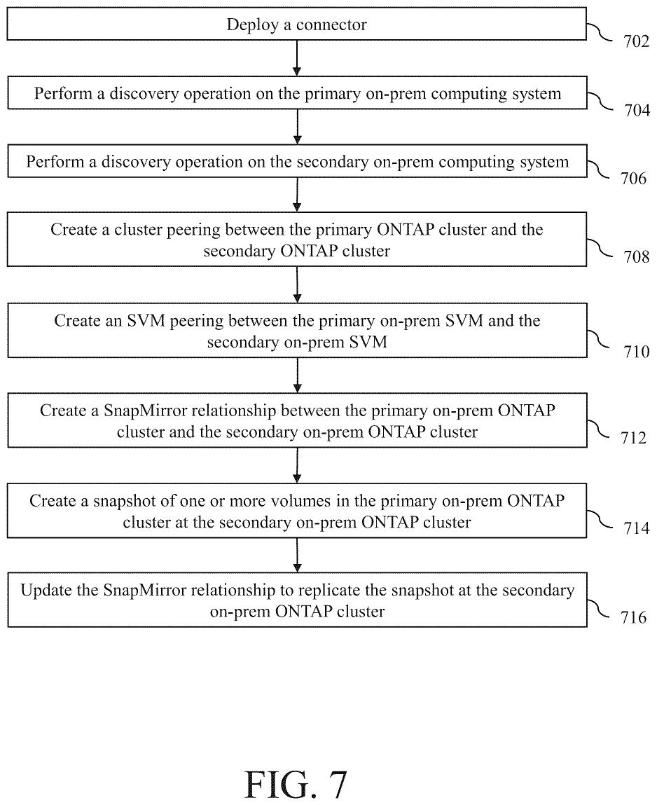

Turning now to FIG. 7, a flow diagram of a process of creating a disaster recovery plan between the primary on-prem computing system 102 and the secondary on-prem computing system 104-1 in accordance with an embodiment of the disclosure is shown. In an embodiment, this process also includes creating one or more backups of the ONTAP cluster 300 in the primary on-prem computing system. After creating the disaster recovery plan, various disaster recovery processes can be executed between the primary on-prem computing system and the secondary on-prem computing system, such as test failover, failover and failback, which are described below. This disaster discovery plan creation process is described with references to FIG. 6.

The process begins at step 702, where the connector 616 is deployed by the cloud-based disaster recovery service 130 in the disaster recovery system 600. The connector 616 may be deployed at the primary on-prem computing system 102 or the secondary on-prem computing system 104-1. In an embodiment, the connector 616 may be deployed as a VM that is configured or programmed to execute tasks related to disaster recovery operations. In another embodiment, the connector 616 may be deployed as a service or an application.

Next, at step 704, a discovery operation is performed on the primary on-prem computing system 102 by the connector 616. The discovery operation on the primary on-prem computing system may be initiated by calls being made to the connector by the cloud-based disaster recovery service 130. In response, the connector executes the discovery operation to retrieve datastore and storage footprint details, and work environment and SVM details, as well as any storage replication relationships, such as SnapMirror relationships. In addition, export path or LUN path received from datastore discovery may also be retrieved. If NFS is being used in the primary on-prem computing system, volume details matching the junction/export path may be retrieved. If SAN is being used in the primary on-prem computing system, LUN details matching the LUN path and serial number may be retrieved. In an embodiment, the cloud-based disaster recovery service may register the volumes/LUNs in a database and generate unique storage IDs corresponding to the volumes/LUNs.

Next, at step 706, a discovery operation is performed on the secondary on-prem computing system 104-1 by the connector 616. The discovery operation on the secondary on-prem computing system may also be initiated by calls being made to the connector by the cloud-based disaster recovery service 130. In response, the connector executes the discovery operation to retrieve the secondary on-prem computing system details, which are similar to the details of the primary on-prem computing system.

Next, at step 708, a cluster peering between the ONTAP cluster 300 in the primary on-prem computing system 102 (“the primary on-prem ONTAP cluster”) and the ONTAP cluster 300b in the secondary on-prem computing system 104-1 (“the secondary on-prem ONTAP cluster”) is established. Cluster peering is the process of establishing a trusted, authenticated communication channel between two ONTAP clusters. In an embodiment, the cluster peering involves instructing the secondary on-prem ONTAP cluster to establish the cluster peering by the cloud-based disaster recovery service 130. In response, a cluster peering request API is transmitted to the primary on-prem ONTAP cluster from the secondary on-prem ONTAP cluster. When the cluster peering request is accepted by the primary on-prem ONTAP cluster, the cluster peering between the primary on-prem ONTAP cluster and the secondary on-prem ONTAP cluster is established, which results in exchange of intercluster LIFs for every node in both clusters. In an embodiment, a REST API is used to establish the cluster peering. The API may be a NetApp ONTAP REST API, e.g., POST/cluster/peers.

Next, at step 710, an SVM peering between the SVM 320 in the primary on-prem computing system 102 (“the primary on-prem SVM”) and the SVM 320b in the secondary on-prem computing system 104-1 (“the secondary on-prem SVM”) is established by the cloud-based disaster recovery service 130. In an embodiment, the SVM peering involves instructing the secondary on-prem ONTAP cluster 300b to establish the SVM peering by the cloud-based disaster recovery service. In response, an SVM peering request API is transmitted to the primary on-prem ONTAP cluster 300 by the secondary on-prem ONTAP cluster. When the SVM peering request is accepted by the primary on-prem ONTAP cluster, the SVM peering between the primary on-prem SVM and the secondary on-prem SVM is established. In an embodiment, a REST API is used to establish the SVM peering. The API may be a NetApp ONTAP REST API, e.g., POST/svm/peers.

Next, at step 712, a SnapMirror relationship, e.g., the SnapMirror relationship 614, is created between the primary on-prem ONTAP cluster 300 and the secondary on-prem ONTAP cluster 300b to replicate data from the primary on-prem ONTAP cluster to the secondary on-prem ONTAP cluster. It is assumed here that this step is being performed because no storage replication relationship is found between the primary on-prem ONTAP cluster 300 and the secondary on-prem ONTAP cluster 300b. The SnapMirror relationship may be created using a SnapMirror create command for a source and a destination endpoint. In an embodiment, a REST API is used to create the SnapMirror relationship. The API may be a NetApp ONTAP REST API, e.g., POST/snapmirror/relationships.

Next, at step 714, a snapshot of one or more volumes in the primary on-prem ONTAP cluster 300 is created at the primary on-prem ONTAP cluster. In an embodiment, a REST API is used to create the snapshot. The API may be a NetApp ONTAP REST API, e.g., POST/storage/volumes/{volume.uuid}/snapshots.

Next, at step 716, the SnapMirror relationship is updated to replicate the snapshot at the secondary on-prem ONTAP cluster 300b. In an embodiment, a REST API is used to update the SnapMirror relationship. The API may be a NetApp ONTAP REST API, e.g., POST/snapmirror/relationships/{relationship.uuid}/transfers.

Consequently, a disaster recovery plan is created between the primary on-prem computing system 102 and the secondary on-prem computing system 104-1, as well as a backup snapshot, which can then be used to execute test failover, failover and failback operations. Additional backup snapshots of the primary on-prem ONTAP cluster may be created at different points in time. This disaster recovery plan may be saved by the cloud-based disaster recovery service 130 and added to a list of disaster recovery plans, which may be maintained by the cloud-based disaster recovery service. One of more of the plans from the list of disaster recovery plans may be selected to perform a disaster recovery operation, such as test failover, failover and failback operations, as well as migration operations.

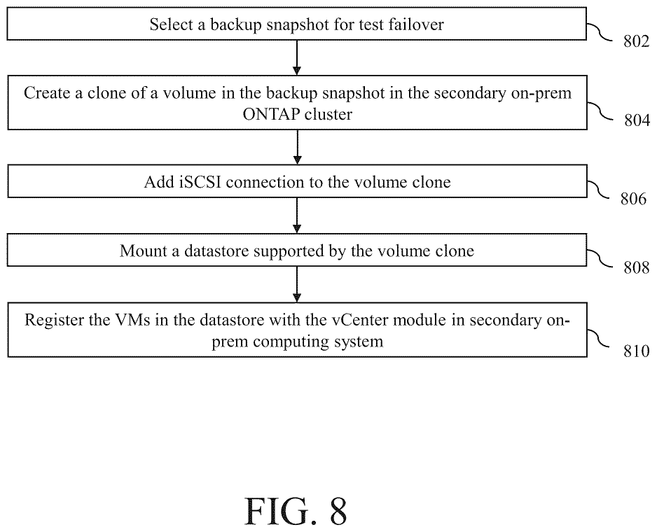

Turning now to FIG. 8, a flow diagram of a process of executing a test failover from the primary on-prem computing system 102 to the secondary on-prem computing system 104-1 in accordance with an embodiment of the disclosure is shown. This process is described with references to FIG. 6.

The process begins at step 802, where a backup snapshot is selected for test failover by the cloud-based disaster recovery service 130. The backup snapshot is a snapshot of one or more volumes from the primary on-prem ONTAP cluster 300, which has been replicated in the secondary on-prem ONTAP cluster 300b. In an embodiment, an administrator may use a user interface (UI) for the cloud-based disaster recovery service to manually enter the backup snapshot for the test failover for a selected disaster recovery plan.

Next, at step 804, a clone of a volume in the backup snapshot is created in the secondary on-prem ONTAP cluster 300b. As used herein, a clone volume is a writable, point-in-time copy of a parent volume. In an embodiment, the volume clone may be a FlexClone volume. The clone of the volume may be created by issuing a volume clone command that specifies the volume in the backup snapshot. In an embodiment, a REST API is used to create the volume clone. The API may be a NetApp ONTAP REST API, e.g., POST/storage/volumes. This step may be repeated when there are multiple volumes in the backup snapshot.

Next, at step 806, iSCSI connection is added to the volume clone to allow the secondary on-prem computing system 104-1 to connect to the volume clone. In an embodiment, one or more APIs or scripts may be used to add the iSCSI connection to the volume clone. For example, one or more automation scripts or tools using ONTAP REST API's may be used to add the iSCSI connection to the volume clone. As an example, an automation script called “/protocols/san/lun-maps” may be used to add the iSCSI connection. This step may be repeated when there are multiple volumes in the backup snapshot that need to be cloned.

Next, at step 808, a datastore supported by the volume clone is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 810, the VMs in the datastore are registered with the vCenter module 544b in the secondary on-prem computing system 104-1, which completes the test failover. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

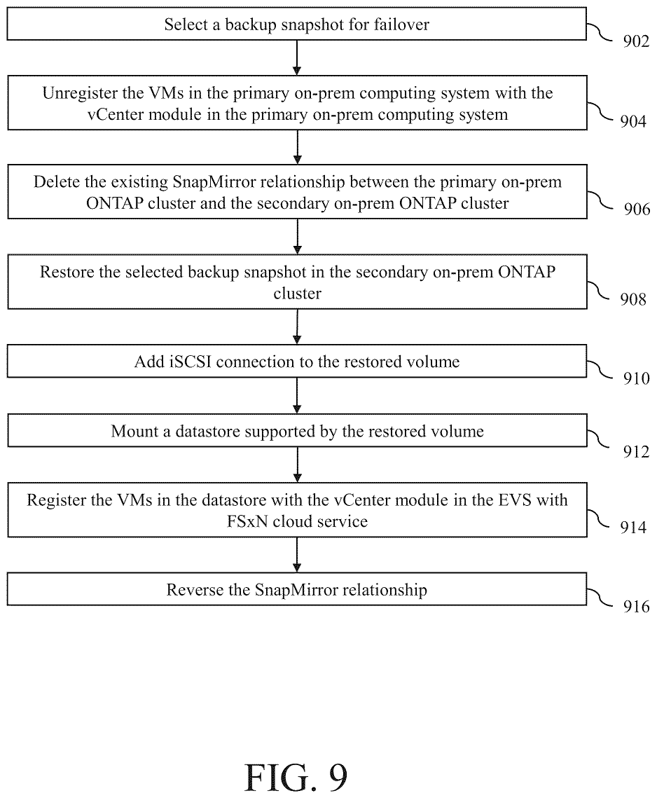

Turning now to FIG. 9, a flow diagram of a process of executing a failover from the primary on-prem computing system 102 to the secondary on-prem computing system 104-1 in accordance with an embodiment of the disclosure is shown. This process is described with references to FIG. 6.

The process begins at step 902, where a backup snapshot is selected for failover by the cloud-based disaster recovery service 130. In an embodiment, an administrator may use the UI for the cloud-based disaster recovery service to manually enter the backup snapshot for the failover for a selected disaster recovery plan.

Next, at step 904, the VMs in the primary on-prem computing system 102 are unregistered with the vCenter module 544 in the primary on-prem computing system. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

Next, at step 906, the existing SnapMirror relationship between the primary on-prem ONTAP cluster 300 and the secondary on-prem ONTAP cluster 300b is deleted by the cloud-based disaster recovery service 130. The existing SnapMirror relationship may be deleted using a snapmirror delete command that specifies the particular SnapMirror relationship. The snapmirror delete command preserves the read-write or read-only attributes of the volumes of a SnapMirror relationship after the relationship is deleted. Therefore, a read-write volume that was the source of a SnapMirror relationship retains its read-write attributes, and a target volume that was a destination of the SnapMirror relationship retains its read-only attributes. In an embodiment, a REST API is used to delete the existing SnapMirror relationship. The API may be a NetApp ONTAP REST API, e.g., DELETE/snapmirror/relationships/{uuid}.

Next, at step 908, the selected backup snapshot is restored in the secondary on-prem ONTAP cluster 300b by the cloud-based disaster recovery service 130. The backup snapshot may be restored using a snapshot restore command that specifies the particular backup snapshot. The snapshot restore command brings one or more volumes in the snapshot to be the active volumes in the secondary on-prem ONTAP cluster. In an embodiment, a REST API is used to restore the backup snapshot. The API may be a NetApp ONTAP REST API, e.g., PATCH/storage/volumes/{uuid}. This step may be repeated when there are multiple volumes in the backup snapshot.

Next, at step 910, iSCSI connection is added to the restored volume to allow the secondary on-prem computing system 104-1 to connect to the restored volume. In an embodiment, one or more APIs or scripts may be used to add the iSCSI connection to the volume. For example, one or more automation scripts or tools using Go library for VMware vSphere APIs may be used to add the iSCSI connection to the volume. As an example, an automation script called “POST/protocols/san/lun-maps” may be used to add the iSCSI connection. This step may be repeated when there are multiple volumes in the backup snapshot.

Next, at step 912, a datastore supported by the restored volume is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 914, the VMs in the datastore are registered with the vCenter module 544b running in the secondary on-prem computing system 104-1. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 916, the SnapMirror relationship is reversed so that the previous source volume in the primary on-prem computing system 102 is now the destination volume for replication and the previous destination volume in the secondary on-prem computing system 104-1 is now the source volume for replication. This process may be executed by creating a new SnapMirror relationship between the primary on-prem ONTAP cluster and the secondary on-prem ONTAP cluster to replicate data from the secondary on-prem ONTAP cluster to the primary on-prem ONTAP cluster. In an embodiment, a REST API is used to reverse the SnapMirror relationship. The API may be a NetApp ONTAP REST API, e.g., POST/snapmirror/relationships.

Once the VMs have been registered, the VMs in the primary on-prem computing system 102 have been migrated to the secondary on-prem computing system 104-1 using the backup snapshot. However, in order to complete the failover process, the SnapMirror relationship is reversed so that the primary on-prem computing system can be used for future failover.

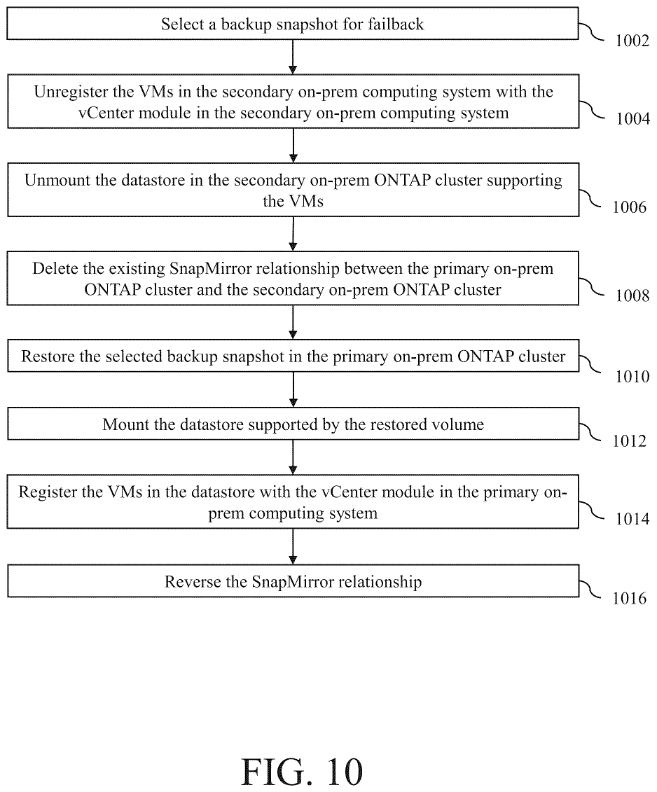

Turning now to FIG. 10, a flow diagram of a process of executing a failback from the secondary on-prem computing system 104-1 to the primary on-prem computing system 102 in accordance with an embodiment of the disclosure is shown. This process is described with references to FIG. 6.

The process begins at step 1002, where a backup snapshot is selected for failback by the cloud-based disaster recovery service 130. In an embodiment, an administrator may use the UI for the cloud-based disaster recovery service to manually enter the backup snapshot for the failback for a selected disaster recovery plan.

Next, at step 1004, the VMs in the secondary on-prem computing system 104-1 are unregistered with the vCenter module 544b in the secondary on-prem computing system. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

At step 1006, the datastore in the secondary on-prem ONTAP cluster 300b supporting the VMs is unmounted so that the datastore can no longer be accessed and used to store data. In an embodiment, one or more APIs or scripts may be used to unmount the datastore. For example, one or more automation scripts or tools using Go library for VMware vSphere APIs may be used to unmount the datastore. As an example, an automation script called “remove” may be used to unmount the datastore.

Next, at step 1008, the existing SnapMirror relationship from the secondary on-prem ONTAP cluster 300b to the primary on-prem ONTAP cluster 300 is deleted by the cloud-based disaster recovery service 130. In an embodiment, a REST API is used to delete the existing SnapMirror relationship. The API may be a NetApp ONTAP REST API, e.g., DELETE/snapmirror/relationships/{uuid}.

Next, at step 1010, the selected backup snapshot is restored in the primary on-prem ONTAP cluster 300 by the cloud-based disaster recovery service 130. The backup snapshot may be restored using a snapshot restore command that specifies the particular backup snapshot. The snapshot restore command brings one or more volumes in the snapshot to be the active volumes in the primary on-prem ONTAP cluster. In an embodiment, a REST API may be used to restore the backup snapshot. The API may be a NetApp ONTAP REST API, e.g., PATCH/storage/volumes/{uuid}. This step may be repeated when there are multiple volumes in the backup snapshot.

Next, at step 1012, the datastore supported by the restored volume in the primary on-prem ONTAP cluster 300 is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “CreateNasDatastore” may be used to mount the datastore.

Next, at step 1014, the VMs in the datastore are registered with the vCenter module 544a in the primary on-prem computing system 102. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 1016, the SnapMirror relationship is reversed so that the previous source volume in the secondary on-prem computing system 104-1 is now the destination volume for replication and the previous destination volume in the primary on-prem computing system 102 is now the source volume for replication. This process may be executed by creating a new SnapMirror relationship between the primary on-prem ONTAP cluster and the secondary on-prem ONTAP cluster to replicate data from the primary on-prem ONTAP cluster to the secondary on-prem ONTAP cluster. In an embodiment, a REST API is used to reverse the SnapMirror relationship. The API may be a NetApp ONTAP REST API, e.g., POST/snapmirror/relationships.

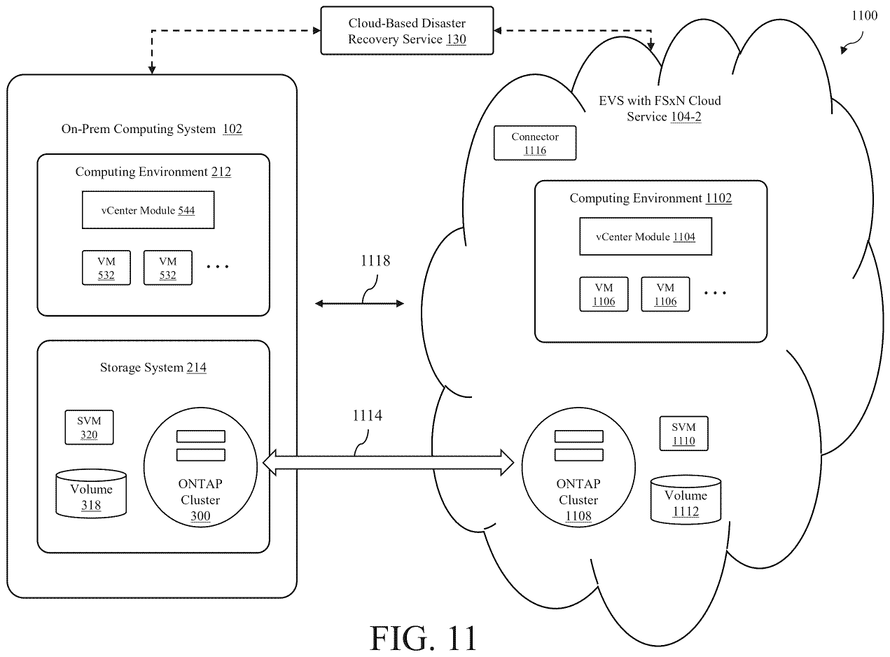

Turning now to FIG. 11, a disaster recovery system 1100 in the distributed computing system 100 formed by the primary site 102 and a secondary site 104-2 of the secondary sites 104 in which the primary site 102 is an on-prem computing system and the secondary site 104-2 is an Elastic VMware Service (EVS) with Amazon FSx for NetApp ONTAP (FSxN) cloud service running in a public cloud computing system in accordance with an embodiment of the disclosure is shown. The EVS with FSxN cloud service can be viewed as a cloud-hosted virtualized computing environment coupled to an externally managed networked storage service operated by the cloud provider. In FIG. 11, the computing environment 212 of the on-prem computing system 102 is shown with only the cluster management center 544 in the form of a vCenter module and the VMs 532. In addition, the storage system 214 of the on-prem computing system 102 is shown with only the ONTAP cluster 300, a representative volume 318 and a representative SVM 320. The on-prem computing system 102 may be used as a protected site and the EVS with FSxN cloud service 104-2 may be used as a backup site, or vice versa. A connection 1118 between the on-prem computing system 102 and the EVS with FSxN cloud service 104-2 is used for communication. In an embodiment, the connection 1118 may be AWS Direct Connect. However, in other embodiments, another type of connection may be used to connect the on-prem computing system 102 to the EVS with FSxN cloud service 104-2.

As shown in FIG. 11, in the EVS with FSxN cloud service 104-2, a computing environment 1102, e.g., a VMware vSphere environment, may be created or deployed. The computing environment 1102 may be used to support a vCenter module 1104 and VMs 1106. An ONTAP cluster 1108 may also be created or deployed in the EVS with FSxN cloud service 104-2. The ONTAP cluster 1108 may be used to support one or more SVMs 1110 and one or more volumes 1112.

The ONTAP cluster 1108 (referred to herein as “the FSxN ONTAP cluster”) may establish a SnapMirror relationship 1114 with the ONTAP cluster 300 in the on-prem computing system 102 (referred to herein as the “on-prem ONTAP cluster”). The SnapMirror relationship may be a replication connection from the on-prem ONTAP cluster to the FSxN ONTAP cluster or vice versa.

The cloud-based disaster recovery service 130 operates to orchestrate disaster recovery operations between the on-prem computing system 102 and the EVS with FSxN cloud service 104-2 using a connector 1116, which can be deployed in the EVS with FSxN cloud service, as illustrated in FIG. 11, or deployed in the on-prem computing system 102. As described below, the connector is used to discover compute and storage details of the on-prem computing system 102 and the EVS with FSxN cloud service 104-2. After the discovery, various disaster recovery operations, such as test failover, failover and failback processes, can be performed.

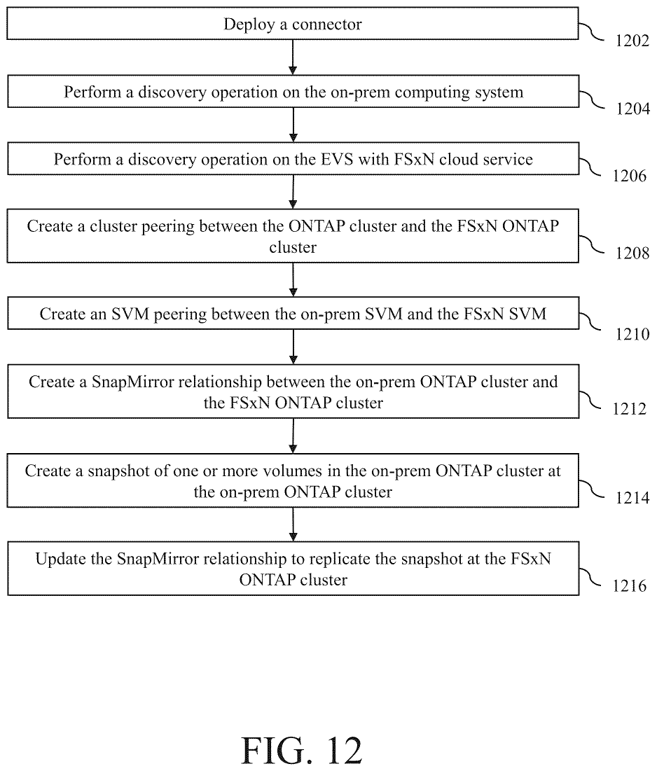

Turning now to FIG. 12, a flow diagram of a process of creating a disaster recovery plan between the on-prem computing system 102 and the EVS with FSxN cloud service 104-2 in accordance with an embodiment of the disclosure is shown. In an embodiment, this process also includes creating one or more backups of the ONTAP cluster 300 in the on-prem computing system. After creating the disaster recovery plan, various disaster recovery processes can be executed between the on-prem computing system and the EVS with FSxN cloud service, such as test failover, failover and failback, which are described below. This process is described with references to FIG. 11.

The process begins at step 1202, where the connector 1116 is deployed by the cloud-based disaster recovery service 130 in the disaster recovery system 1100. The connector 1116 may be deployed at the on-prem computing system 102 or the EVS with FSxN cloud service 104-2. In an embodiment, the connector 1116 may be deployed as a VM that is configured or programmed to execute tasks related to disaster recovery operations. In another embodiment, the connector 1116 may be deployed as a service or an application.

Next, at step 1204, a discovery operation is performed on the on-prem computing system 102 by the connector 1116. The discovery operation on the on-prem computing system may be initiated by calls being made to the connector by the cloud-based disaster recovery service 130. In response, the connector executes the discovery operation to retrieve datastore and storage footprint details, and work environment and SVM details. In addition, export path or LUN path received from datastore discovery may also be retrieved. If NFS is being used in the on-prem computing system, volume details matching the junction/export path may be retrieved. If SAN is being used in the on-prem computing system, LUN details matching the LUN path and serial number may be retrieved. In an embodiment, the cloud-based disaster recovery service may register the volumes/LUNs in a database and generate unique storage IDs corresponding to the volumes/LUNs.

Next, at step 1206, a discovery operation is performed on the EVS with FSxN cloud service 104-2 by the connector 1116. The discovery operation on the EVS with FSxN cloud service may also be initiated by calls being made to the connector by the cloud-based disaster recovery service 130. In response, the connector executes the discovery operation to retrieve the EVS with FSxN cloud service details, which may include its resources, datastore and storage footprint details, and work environment and SVM details, as well as any storage replication relationships, such as SnapMirror relationships. As an example, the identified EVS resources may include, but not limited, any vCenter instances running inside the EVS with FSxN cloud service, such as the vCenter module 1104, hosts and networking details, such as NSX segments and VLANs.

Next, at step 1208, a cluster peering between the ONTAP cluster 300 in the on-prem storage system 214 (“the on-prem ONTAP cluster”) and the ONTAP cluster 1108 in the EVS with FSxN cloud service 104-2 (“the FSxN ONTAP cluster”) is established. Cluster peering is the process of establishing a trusted, authenticated communication channel between two ONTAP clusters. In an embodiment, the cluster peering involves instructing the FSxN ONTAP cluster to establish the cluster peering by the cloud-based disaster recovery service 130. In response, a cluster peering request API is transmitted to the on-prem ONTAP cluster from the FSxN ONTAP cluster. When the cluster peering request is accepted by the on-prem ONTAP cluster, the cluster peering between the on-prem ONTAP cluster and the FSxN ONTAP cluster is established, which results in exchange of intercluster LIFs for every node in both clusters. If there is no existing FSxN ONTAP cluster in the EVS with FSxN cloud service, a new FSxN ONTAP cluster is deployed in the EVS with FSxN cloud service by the connector 1116. In an embodiment, a REST API is used to establish the cluster peering. The API may be a NetApp ONTAP REST API, e.g., POST/cluster/peers.

Next, at step 1210, an SVM peering between the SVM 320 in the on-prem storage system 214 (“the on-prem SVM”) and the SVM 1110 in the EVS with FSxN cloud service 104-2 (“the FSxN SVM”) is established by the cloud-based disaster recovery service 130. In an embodiment, the SVM peering involves instructing the FSxN ONTAP cluster 1108 to establish the SVM peering by the cloud-based disaster recovery service. In response, an SVM peering request API is transmitted to the on-prem ONTAP cluster 300 by the FSxN ONTAP cluster. When the SVM peering request is accepted by the on-prem ONTAP cluster, the SVM peering between the on-prem SVM and the FSxN SVM is established. If there is no existing FSxN SVM in the EVS with FSxN cloud service, a new FSxN SVM is deployed in the EVS with FSxN cloud service by the connector 1116. In an embodiment, a REST API is used to establish the SVM peering. The API may be a NetApp ONTAP REST API, e.g., POST/svm/peers.

Next, at step 1212, a SnapMirror relationship, e.g., the SnapMirror relationship 1114, is created between the on-prem ONTAP cluster 300 and the FSxN ONTAP cluster 1108 to replicate data from the on-prem ONTAP cluster to the FSxN ONTAP cluster. It is assumed here that this step is being performed because no storage replication relationship is found between the on-prem ONTAP cluster 300 and the FSxN ONTAP cluster 1108. The SnapMirror relationship may be created using a SnapMirror create command for a source and a destination endpoint. In an embodiment, a REST API is used to create the SnapMirror relationship. The API may be a NetApp ONTAP REST API, e.g., POST/snapmirror/relationships.

Next, at step 1214, a snapshot of one or more volumes in the on-prem ONTAP cluster 300 is created at the on-prem ONTAP cluster. In an embodiment, a REST API is used to create the snapshot. The API may be a NetApp ONTAP REST API, e.g., POST/storage/volumes/{volume.uuid}/snapshots.

Next, at step 1216, the SnapMirror relationship is updated to replicate the snapshot at the FSxN ONTAP cluster 1108. In an embodiment, a REST API is used to create the snapshot. The API may be a NetApp ONTAP REST API, e.g., POST/snapmirror/relationships/{relationship.uuid}/transfers.

Consequently, a disaster recovery plan is created between the on-prem computing system 102 and the EVS with FSxN cloud service 104-2, as well as a backup snapshot, which can then be used to execute test failover, failover and failback operations. Additional backup snapshots of the on-prem ONTAP cluster may be created at different points in time. This disaster recovery plan may be saved by the cloud-based disaster recovery service 130 and added to a list of disaster recovery plans, which may be maintained by the cloud-based disaster recovery service. One of more of the plans from the list of disaster recovery plans may be selected to perform a disaster recovery operation, such as test failover, failover and failback operations, as well as migration operations.

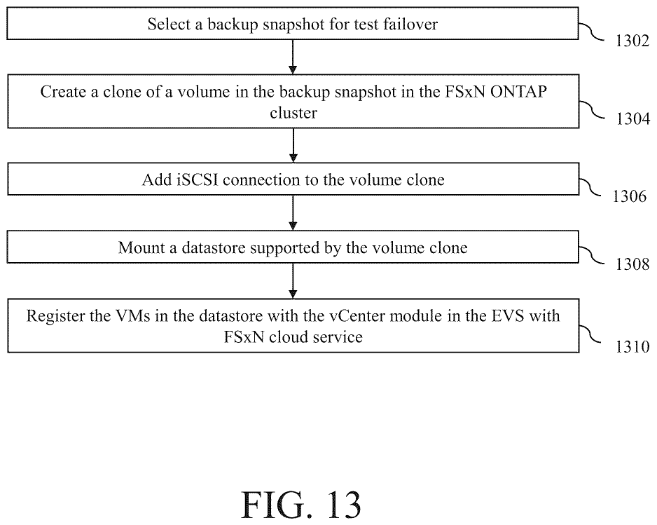

Turning now to FIG. 13, a flow diagram of a process of executing a test failover from the on-prem computing system 102 to the EVS with FSxN cloud service 104-2 in accordance with an embodiment of the disclosure is shown. This process is described with references to FIG. 11.

The process begins at step 1302, where a backup snapshot is selected for test failover by the cloud-based disaster recovery service 130. The backup snapshot is a snapshot of one or more volumes from the on-prem ONTAP cluster 300, which has been replicated in the FSxN ONTAP cluster 1108. In an embodiment, an administrator may use the UI for the cloud-based disaster recovery service to manually enter the backup snapshot for the test failover for a selected disaster recovery plan.

Next, at step 1304, a clone of a volume in the backup snapshot is created in the FSxN ONTAP cluster 1108. As used herein, a clone volume is a writable, point-in-time copy of a parent volume. In an embodiment, the volume clone may be a FlexClone volume. The clone of the volume may be created by issuing a volume clone command that specifies the volume in the backup snapshot. In an embodiment, a REST API is used to create the volume clone. The API may be a NetApp ONTAP REST API, e.g., POST/storage/volumes. This step may be repeated when there are multiple volumes in the backup snapshot.

Next, at step 1306, iSCSI connection is added to the volume clone to allow the EVS to connect to the volume clone. In an embodiment, one or more APIs or scripts may be used to add the iSCSI connection to the volume clone. For example, one or more automation scripts or tools using ONTAP REST API's may be used to add the iSCSI connection to the volume clone. As an example, an automation script called “/protocols/san/lun-maps” may be used to add the iSCSI connection. This step may be repeated when there are multiple volumes in the backup snapshot that need to be cloned.

Next, at step 1308, a datastore supported by the volume clone is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 1310, the VMs in the datastore are registered with the vCenter module 1104 in the EVS with FSxN cloud service 104-2, which completes the test failover. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

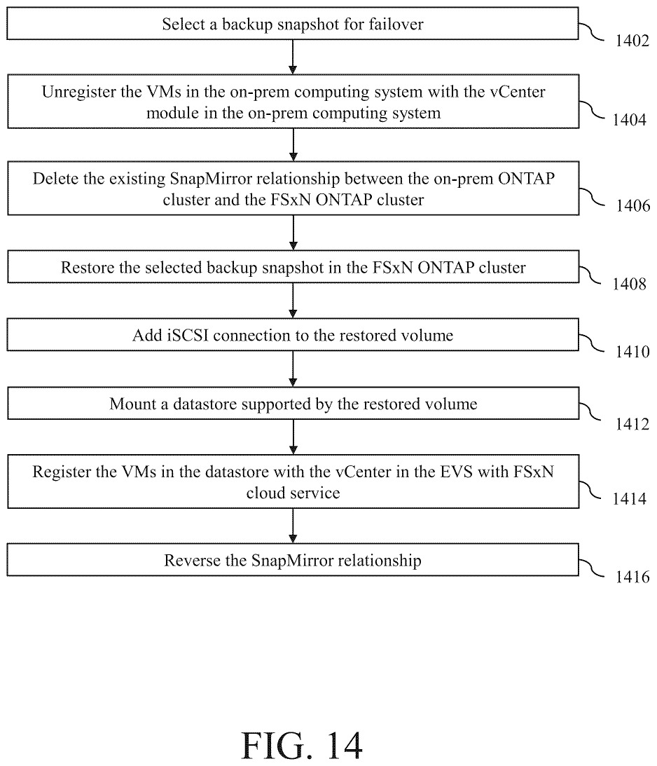

Turning now to FIG. 14, a flow diagram of a process of executing a failover from the on-prem computing system 102 to the EVS with FSxN cloud service 104-2 in accordance with an embodiment of the disclosure is shown. This process is described with references to FIG. 11.

The process begins at step 1402, where a backup snapshot is selected for failover by the cloud-based disaster recovery service 130. In an embodiment, an administrator may use the UI for the cloud-based disaster recovery service to manually enter the backup snapshot for the failover for a selected disaster recovery plan.

Next, at step 1404, the VMs in the on-prem computing system 102 are unregistered with the vCenter module 544 in the on-prem computing system. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

Next, at step 1406, the existing SnapMirror relationship between the on-prem ONTAP cluster 300 and the FSxN ONTAP cluster 1108 is deleted by the cloud-based disaster recovery service 130. The existing SnapMirror relationship may be deleted using a snapmirror delete command that specifies the particular SnapMirror relationship. The snapmirror delete command preserves the read-write or read-only attributes of the volumes of a SnapMirror relationship after the relationship is deleted. Therefore, a read-write volume that was the source of a SnapMirror relationship retains its read-write attributes, and a target volume that was a destination of the SnapMirror relationship retains its read-only attributes. In an embodiment, a REST API is used to delete the existing SnapMirror relationship. The API may be a NetApp ONTAP REST API, e.g., DELETE/snapmirror/relationships/{uuid}.

Next, at step 1408, the selected backup snapshot is restored in the FSxN ONTAP cluster 1108 by the cloud-based disaster recovery service 130. The backup snapshot may be restored using a snapshot restore command that specifies the particular backup snapshot. The snapshot restore command brings one or more volumes in the snapshot to be the active volumes in the FSxN ONTAP cluster. In an embodiment, a REST API is used to restore the backup snapshot. The API may be a NetApp ONTAP REST API, e.g., PATCH/storage/volumes/{uuid}. This step may be repeated when there are multiple volumes in the backup snapshot.

Next, at step 1410, iSCSI connection is added to the restored volume to allow the EVS with FSxN cloud service 104-2 to connect to the restored volume. In an embodiment, one or more APIs or scripts may be used to add the iSCSI connection to the volume. For example, one or more automation scripts or tools using Go library for VMware vSphere APIs may be used to add the iSCSI connection to the volume. As an example, an automation script called “POST/protocols/san/lun-maps” may be used to add the iSCSI connection. This step may be repeated when there are multiple volumes in the backup snapshot.

Next, at step 1412, a datastore supported by the restored volume is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 1414, the VMs in the datastore are registered with the vCenter module 1104 running in the EVS with FSxN cloud service 104-2. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 1416, the SnapMirror relationship is reversed so that the previous source volume in the on-prem computing system 102 is now the destination volume for replication and the previous destination volume in the EVS with FSxN cloud service 104-2 is now the source volume for replication. This process may be executed by creating a new SnapMirror relationship between the on-prem ONTAP cluster and the FSxN ONTAP cluster to replicate data from the FSxN ONTAP cluster to the on-prem ONTAP cluster. In an embodiment, a REST API is used to reverse the SnapMirror relationship. The API may be a NetApp ONTAP REST API, e.g., POST/snapmirror/relationships.

Once the VMs have been registered, the VMs in the on-prem computing system 102 have been migrated to the EVS with FSxN cloud service 104-2 using the backup snapshot. However, in order to complete the failover process, the SnapMirror relationship is reversed so that the on-prem computing system can be used for future failover.

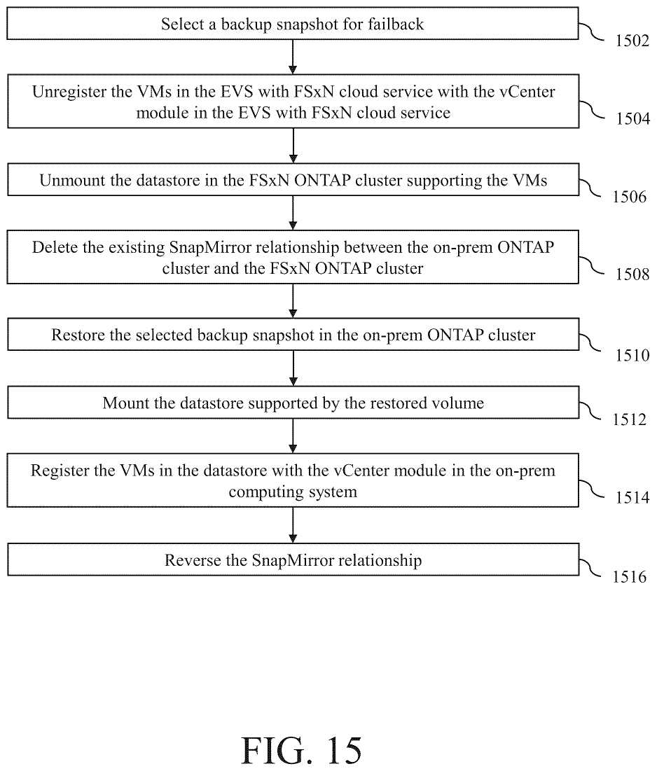

Turning now to FIG. 15, a flow diagram of a process of executing a failback from the EVS with FSxN cloud service 104-2 to the on-prem computing system 102 in accordance with an embodiment of the disclosure is shown. This process is described with references to FIG. 11.

The process begins at step 1502, where a backup snapshot is selected for failback by the cloud-based disaster recovery service 130. In an embodiment, an administrator may use the UI for the cloud-based disaster recovery service to manually enter the backup snapshot for the failback for a selected disaster recovery plan.

Next, at step 1504, the VMs in the EVS with FSxN service 104-2 are unregistered with the vCenter module 1104 in the EVS with FSxN service. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

At step 1506, the datastore in the FSxN ONTAP cluster 1108 supporting the VMs is unmounted so that the datastore can no longer be accessed and used to store data. In an embodiment, one or more APIs or scripts may be used to unmount the datastore. For example, one or more automation scripts or tools using Go library for VMware vSphere APIs may be used to unmount the datastore. As an example, an automation script called “remove” may be used to unmount the datastore.

Next, at step 1508, the existing SnapMirror relationship from the FSxN ONTAP cluster 1108 to the on-prem ONTAP cluster 300 is deleted by the cloud-based disaster recovery service 130. In an embodiment, a REST API is used to delete the existing SnapMirror relationship. The API may be a NetApp ONTAP REST API, e.g., DELETE/snapmirror/relationships/{uuid}.

Next, at step 1510, the selected backup snapshot is restored in the on-prem ONTAP cluster 300 by the cloud-based disaster recovery service 130. The backup snapshot may be restored using a snapshot restore command that specifies the particular backup snapshot. The snapshot restore command brings one or more volumes in the snapshot to be the active volumes in the on-prem ONTAP cluster. In an embodiment, a REST API may be used to restore the backup snapshot. The API may be a NetApp ONTAP REST API, e.g., PATCH/storage/volumes/{uuid}. This step may be repeated when there are multiple volumes in the backup snapshot.

Next, at step 1512, the datastore supported by the restored volume in the on-prem ONTAP cluster 300 is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “CreateNasDatastore” may be used to mount the datastore.

Next, at step 1514, the VMs in the datastore are registered with the vCenter module 544 in the on-prem computing system 102. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 1516, the SnapMirror relationship is reversed so that the previous source volume in the EVS with FSxN service 104-2 is now the destination volume for replication and the previous destination volume in the on-prem computing system 102 is now the source volume for replication. This process may be executed by creating a new SnapMirror relationship between the on-prem ONTAP cluster and the FSxN ONTAP cluster to replicate data from the on-prem ONTAP cluster to the FSxN ONTAP cluster. In an embodiment, a REST API is used to reverse the SnapMirror relationship. The API may be a NetApp ONTAP REST API, e.g., POST/snapmirror/relationships.

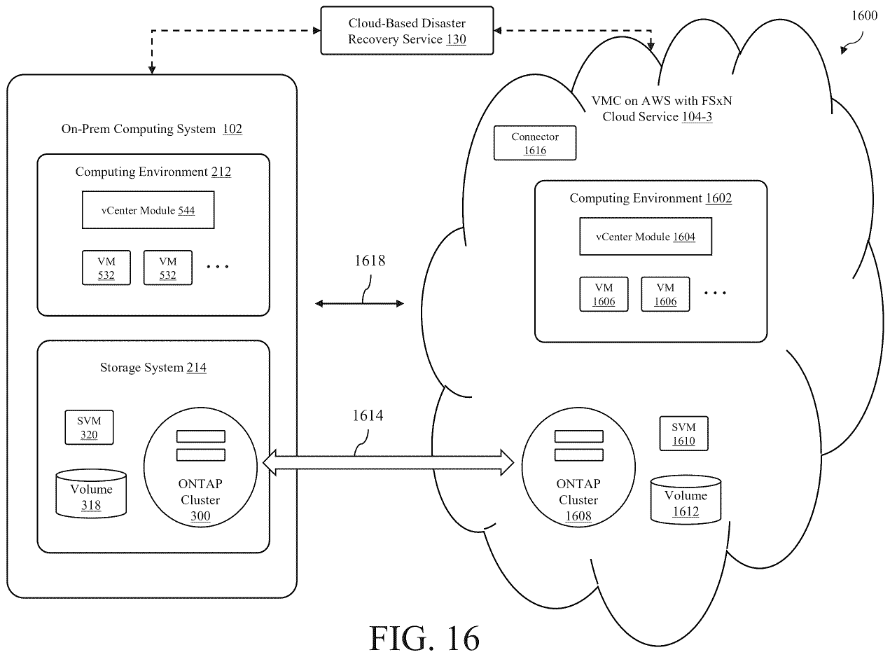

Turning now to FIG. 16, a disaster recovery system 1600 in the distributed computing system 100 formed by the primary site 102 and a secondary site 104-3 of the secondary sites 104 in which the primary site 102 is an on-prem computing system and the secondary site 104-3 is a VMware Cloud on AWS (VMC on AWS) with FSxN cloud service in accordance with an embodiment of the disclosure is shown. The VMC on AWS with FSxN cloud service can be viewed as a cloud-hosted virtualized computing environment in which a virtualization control plane is operated by a third-party virtualization provider and coupled to an externally managed networked storage service. In FIG. 16, the computing environment 212 of the on-prem computing system 102 is shown with only the cluster management center 544 in the form of a vCenter module and the VMs 532. In addition, the storage system 214 of the on-prem computing system 102 is shown with only the ONTAP cluster 300, a representative volume 318 and a representative SVM 320. The on-prem computing system 102 may be used as a protected site and the VMC on AWS with FSxN cloud service 104-3 may be used as a backup site, or vice versa. A connection 1618 between the on-prem computing system 102 and the VMC on AWS with FSxN cloud service 104-3 is used for communication. In an embodiment, the connection 1618 may be AWS Direct Connect. However, in other embodiments, another type of connection 1618 may be used to connect the on-prem computing system 102 to the VMC on AWS with FSxN cloud service 104-3.

As shown in FIG. 16, in the VMC on AWS with FSxN cloud service 104-3, a computing environment 1602, e.g., a VMware vSphere environment, may be created or deployed. The computing environment 1602 may be used to support a vCenter module 1604 and VMs 1606. An ONTAP cluster 1608 may also be created or deployed in the VMC on AWS with FSxN cloud service 104-3. The ONTAP cluster 1608 may be used to support one or more SVMs 1610 and one or more volumes 1612. The ONTAP cluster 1608 (referred to herein as “the VMC FSxN ONTAP cluster”) may establish a SnapMirror relationship 1614 with the ONTAP cluster 300 in the on-prem computing system 102 (referred to herein as the “on-prem ONTAP cluster”). The SnapMirror relationship may be a replication connection from the on-prem ONTAP cluster to the VMC FSxN ONTAP cluster or vice versa.

The cloud-based disaster recovery service 130 operates to orchestrate disaster recovery operations between the on-prem computing system 102 and the VMC on AWS with FSxN cloud service 104-3 using a connector 1616, which can be deployed in the VMC on AWS with FSxN cloud service, as illustrated in FIG. 16, or deployed in the on-prem computing system 102. As described below, the connector is used to discover compute and storage details of the on-prem computing system 102 and the VMC on AWS with FSxN cloud service 104-3. After the discovery, various disaster recovery operations, such as test failover, failover and failback processes, can be performed.

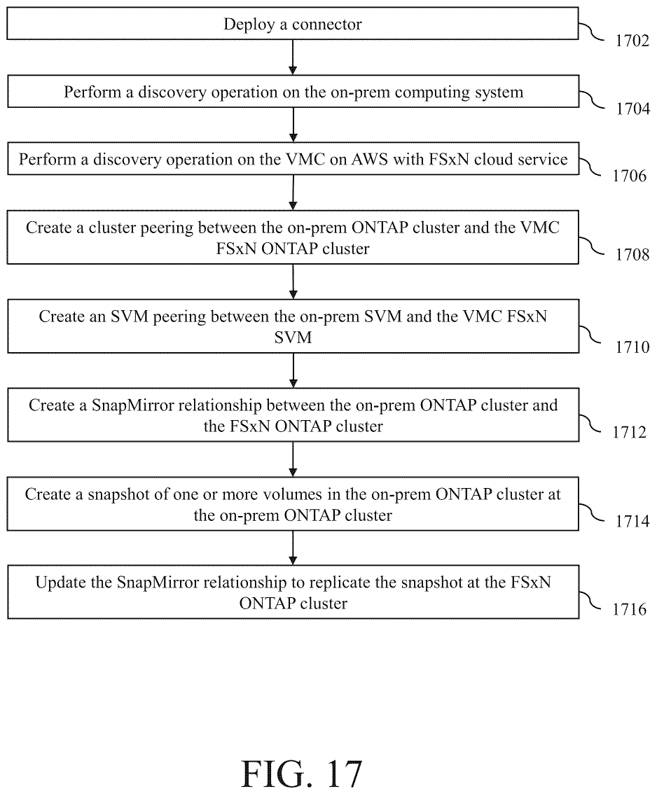

Turning now to FIG. 17, a flow diagram of a process of creating a disaster recovery plan between the on-prem computing system 102 and the VMC on AWS with FSxN cloud service 104-3 in accordance with an embodiment of the disclosure is shown. In an embodiment, this process also includes creating one or more backups of the ONTAP cluster 300 in the on-prem computing system. After creating the disaster recovery plan, various disaster recovery processes can be executed between the on-prem computing system and the VMC on AWS with FSxN cloud service, such as test failover, failover and failback, which are described below. This process is described with references to FIG. 16.

The process begins at step 1702, where the connector 1616 is deployed by the cloud-based disaster recovery service 130 in the disaster recovery system 1600. The connector 1616 may be deployed at the on-prem computing system 102 or the VMC on AWS with FSxN cloud service 104-3. In an embodiment, the connector 1616 may be deployed as a VM that is configured or programmed to execute tasks related to disaster recovery operations. In another embodiment, the connector 1616 may be deployed as a service or an application.

Next, at step 1704, a discovery operation is performed on the on-prem computing system 102 by the connector 1616. The discovery operation on the on-prem computing system may be initiated by calls being made to the connector by the cloud-based disaster recovery service 130. In response, the connector executes the discovery operation to retrieve datastore and storage footprint details, and work environment and SVM details, as well as any storage replication relationships, such as SnapMirror relationships. In addition, export path or LUN path received from datastore discovery may also be retrieved. If NFS is being used in the on-prem computing system, volume details matching the junction/export path may be retrieved. If SAN is being used in the on-prem computing system, LUN details matching the LUN path and serial number may be retrieved. In an embodiment, the cloud-based disaster recovery service may register the volumes/LUNs in a database and generate unique storage IDs corresponding to the volumes/LUNs.

Next, at step 1706, a discovery operation is performed on the VMC on AWS with FSxN cloud service 104-3 by the connector 1616. The discovery operation on the VMC on AWS with FSxN cloud service may also be initiated by calls being made to the connector by the cloud-based disaster recovery service 130. In response, the connector executes the discovery operation to retrieve the VMC on AWS with FSxN cloud service details, which may include its resources, datastore and storage footprint details, and work environment and SVM details. As an example, the identified VMC resources may include, but not limited, any vCenter instances running inside the VMC on AWS with FSxN cloud service, such as the vCenter module 1604, hosts and networking details, such as NSX segments and VLANs.

Next, at step 1708, a cluster peering between the ONTAP cluster 300 in the on-prem storage system 214 (“the on-prem ONTAP cluster”) and the ONTAP cluster 1608 in the VMC on AWS with FSxN cloud service 104-3 (“the VMC FSxN ONTAP cluster”) is established. Cluster peering is the process of establishing a trusted, authenticated communication channel between two ONTAP clusters. In an embodiment, the cluster peering involves instructing the VMC FSxN ONTAP cluster to establish the cluster peering by the cloud-based disaster recovery service 130. In response, a cluster peering request API is transmitted to the on-prem ONTAP cluster from the VMC FSxN ONTAP cluster. When the cluster peering request is accepted by the on-prem ONTAP cluster, the cluster peering between the on-prem ONTAP cluster and the VMC FSxN ONTAP cluster is established, which results in exchange of intercluster LIFs for every node in both clusters. If there is no existing VMC FSxN ONTAP cluster in the VMC on AWS with FSxN cloud service, a new VMC FSxN ONTAP cluster is deployed in the VMC on AWS with FSxN cloud service by the connector 1616. In an embodiment, a REST API is used to establish the cluster peering. The API may be a NetApp ONTAP REST API, e.g., POST/cluster/peers.

Next, at step 1710, an SVM peering between the SVM 320 in the on-prem storage system 214 (“the on-prem SVM”) and the SVM 1610 in the VMC on AWS with FSxN cloud service 104-3 (“the VMC FSxN SVM”) is established by the cloud-based disaster recovery service 130. In an embodiment, the SVM peering involves instructing the VMC FSxN ONTAP cluster 1608 to establish the SVM peering by the cloud-based disaster recovery service. In response, an SVM peering request API is transmitted to the on-prem ONTAP cluster 300 by the VMC FSxN ONTAP cluster. When the SVM peering request is accepted by the on-prem ONTAP cluster, the SVM peering between the on-prem SVM and the VMC FSxN SVM is established. If there is no existing VMC FSxN SVM in the VMC on AWS with FSxN cloud service, a new VMC FSxN SVM is deployed in the VMC on AWS with FSxN cloud service by the connector 1616. In an embodiment, a REST API is used to establish the SVM peering. The API may be a NetApp ONTAP REST API, e.g., POST/svm/peers.

Next, at step 1712, a SnapMirror relationship, e.g., the SnapMirror relationship 1614, is created between the on-prem ONTAP cluster 300 and the VMC FSxN ONTAP cluster 1608 to replicate data from the on-prem ONTAP cluster to the VMC FSxN ONTAP cluster. It is assumed here that this step is being performed because no storage replication relationship is found between the on-prem ONTAP cluster 300 and the VMC FSxN ONTAP cluster 1608. The SnapMirror relationship may be created using a SnapMirror create command for a source and a destination endpoint. In an embodiment, a REST API is used to create the SnapMirror relationship. The API may be a NetApp ONTAP REST API, e.g., POST/snapmirror/relationships.

Next, at step 1714, a snapshot of one or more volumes in the on-prem ONTAP cluster 300 is created at the on-prem ONTAP cluster. In an embodiment, a REST API is used to create the snapshot. The API may be a NetApp ONTAP REST API, e.g., POST/storage/volumes/{volume.uuid}/snapshots.

Next, at step 1716, the SnapMirror relationship is updated to replicate the snapshot at the VMC FSxN ONTAP cluster 1608. In an embodiment, a REST API is used to create the snapshot. The API may be a NetApp ONTAP REST API, e.g., POST/snapmirror/relationships/{relationship. uuid}/transfers.

Consequently, a disaster recovery plan is created between the on-prem computing system 102 and the VMC on AWS with FSxN cloud service 104-3, as well as a backup snapshot, which can then be used to execute test failover, failover and failback operations. Additional backup snapshots of the on-prem ONTAP cluster may be created at different points in time. This disaster recovery plan may be saved by the cloud-based disaster recovery service 130 and added to a list of disaster recovery plans, which may be maintained by the cloud-based disaster recovery service. One of more of the plans from the list of disaster recovery plans may be selected to perform a disaster recovery operation, such as test failover, failover and failback operations, as well as migration operations.

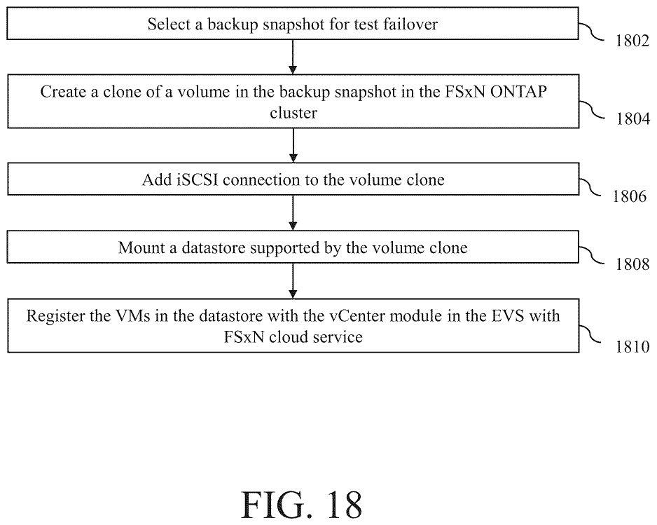

Turning now to FIG. 18, a flow diagram of a process of executing a test failover from the on-prem computing system 102 to the VMC on AWS with FSxN cloud service 104-3 in accordance with an embodiment of the disclosure is shown. This process is described with references to FIG. 16.

The process begins at step 1802, where a backup snapshot is selected for test failover by the cloud-based disaster recovery service 130. The backup snapshot is a snapshot of one or more volumes from the on-prem ONTAP cluster 300, which has been replicated in the VMC FSxN ONTAP cluster 1608. In an embodiment, an administrator may use the UI for the cloud-based disaster recovery service to manually enter the backup snapshot for the test failover for a selected disaster recovery plan.

Next, at step 1804, a clone of a volume in the backup snapshot is created in the VMC FSxN ONTAP cluster 1608. As used herein, a clone volume is a writable, point-in-time copy of a parent volume. In an embodiment, the volume clone may be a FlexClone volume. The clone of the volume may be created by issuing a volume clone command that specifies the volume in the backup snapshot. In an embodiment, a REST API is used to create the volume clone. The API may be a NetApp ONTAP REST API, e.g., POST/storage/volumes. This step may be repeated when there are multiple volumes in the backup snapshot.

Next, at step 1806, iSCSI connection is added to the volume clone to allow the VMC on AWS with FSxN cloud service 104-3 to connect to the volume clone. In an embodiment, one or more APIs or scripts may be used to add the iSCSI connection to the volume clone. For example, one or more automation scripts or tools using ONTAP REST API's may be used to add the iSCSI connection to the volume clone. As an example, an automation script called “/protocols/san/lun-maps” may be used to add the iSCSI connection. This step may be repeated when there are multiple volumes in the backup snapshot that need to be cloned.

Next, at step 1808, a datastore supported by the volume clone is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 1810, the VMs in the datastore are registered with the vCenter module 1604 in the VMC on AWS with FSxN cloud service 104-3, which completes the test failover. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

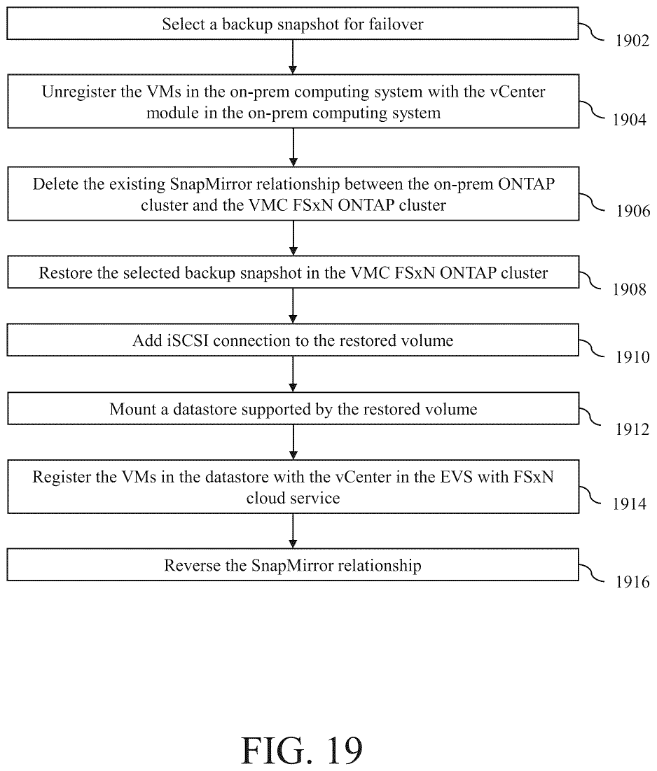

Turning now to FIG. 19, a flow diagram of a process of executing a failover from the on-prem computing system 102 to the VMC on AWS with FSxN cloud service 104-3 in accordance with an embodiment of the disclosure is shown. This process is described with references to FIG. 16.

The process begins at step 1902, where a backup snapshot is selected for failover by the cloud-based disaster recovery service 130. In an embodiment, an administrator may use the UI for the cloud-based disaster recovery service to manually enter the backup snapshot for the failover for a selected disaster recovery plan.

Next, at step 1904, the VMs in the on-prem computing system 102 are unregistered with the vCenter module 544 in the on-prem computing system. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

Next, at step 1906, the existing SnapMirror relationship between the on-prem ONTAP cluster 300 and the VMC FSxN ONTAP cluster 1608 is deleted by the cloud-based disaster recovery service 130. The existing SnapMirror relationship may be deleted using a snapmirror delete command that specifies the particular SnapMirror relationship. The snapmirror delete command preserves the read-write or read-only attributes of the volumes of a SnapMirror relationship after the relationship is deleted. Therefore, a read-write volume that was the source of a SnapMirror relationship retains its read-write attributes, and a target volume that was a destination of the SnapMirror relationship retains its read-only attributes. In an embodiment, a REST API is used to delete the existing SnapMirror relationship. The API may be a NetApp ONTAP REST API, e.g., DELETE/snapmirror/relationships/{uuid}.

Next, at step 1908, the selected backup snapshot is restored in the VMC FSxN ONTAP cluster 1608 by the cloud-based disaster recovery service 130. The backup snapshot may be restored using a snapshot restore command that specifies the particular backup snapshot. The snapshot restore command brings one or more volumes in the snapshot to be the active volumes in the VMC FSxN ONTAP cluster. In an embodiment, a REST API is used to restore the backup snapshot. The API may be a NetApp ONTAP REST API, e.g., PATCH/storage/volumes/{uuid}. This step may be repeated when there are multiple volumes in the backup snapshot.

Next, at step 1910, iSCSI connection is added to the restored volume to allow the VMC on AWS with FSxN cloud service 104-3 to connect to the restored volume. In an embodiment, one or more APIs or scripts may be used to add the iSCSI connection to the volume. For example, one or more automation scripts or tools using Go library for VMware vSphere APIs may be used to add the iSCSI connection to the volume. As an example, an automation script called “POST/protocols/san/lun-maps” may be used to add the iSCSI connection. This step may be repeated when there are multiple volumes in the backup snapshot.

Next, at step 1912, a datastore supported by the restored volume is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “ResignatureUnresolvedVmfsVolumes” may be used to mount the datastore.

Next, at step 1914, the VMs in the datastore are registered with the vCenter module 1604 running in the VMC on AWS with FSxN cloud service 104-3. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 1916, the SnapMirror relationship is reversed so that the previous source volume in the on-prem computing system 102 is now the destination volume for replication and the previous destination volume in the VMC on AWS with FSxN cloud service 104-3 is now the source volume for replication. This process may be executed by creating a new SnapMirror relationship between the on-prem ONTAP cluster 300 and the VMC FSxN ONTAP cluster to replicate data from the VMC FSxN ONTAP cluster to the on-prem ONTAP cluster. In an embodiment, a REST API is used to reverse the SnapMirror relationship. The API may be a NetApp ONTAP REST API, e.g., POST/snapmirror/relationships.

Once the VMs have been registered, the VMs in the on-prem computing system 102 have been migrated to the VMC on AWS with FSxN cloud service 104-3 using the backup snapshot. However, in order to complete the failover process, the SnapMirror relationship is reversed so that the on-prem computing system can be used for future failover.

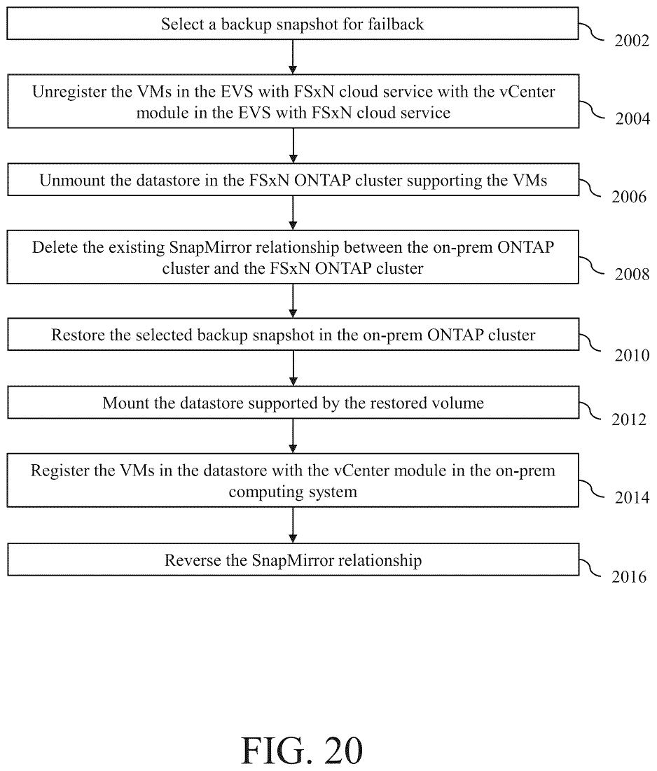

Turning now to FIG. 20, a flow diagram of a process of executing a failback from the VMC on AWS with FSxN cloud service 104-3 to the on-prem computing system 102 in accordance with an embodiment of the disclosure is shown. This process is described with references to FIG. 16.

The process begins at step 2002, where a backup snapshot is selected for failback by the cloud-based disaster recovery service 130. In an embodiment, an administrator may use the UI for the cloud-based disaster recovery service to manually enter the backup snapshot for the failback for a selected disaster recovery plan.

Next, at step 2004, the VMs in the VMC on AWS with FSxN service 104 are unregistered with the vCenter module 1604 in the VMC on AWS with FSxN service. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

At step 2006, the datastore in the VMC FSxN ONTAP cluster 1608 supporting the VMs is unmounted so that the datastore can no longer be accessed and used to store data. In an embodiment, one or more APIs or scripts may be used to unmount the datastore. For example, one or more automation scripts or tools using Go library for VMware vSphere APIs may be used to unmount the datastore. As an example, an automation script called “remove” may be used to unmount the datastore.

Next, at step 2008, the existing SnapMirror relationship from the VMC FSxN ONTAP cluster 1608 to the on-prem ONTAP cluster 300 is deleted by the cloud-based disaster recovery service 130. In an embodiment, a REST API is used to delete the existing SnapMirror relationship. The API may be a NetApp ONTAP REST API, e.g., DELETE/snapmirror/relationships/{uuid}.

Next, at step 2010, the selected backup snapshot is restored in the on-prem ONTAP cluster 300 by the cloud-based disaster recovery service 130. The backup snapshot may be restored using a snapshot restore command that specifies the particular backup snapshot. The snapshot restore command brings one or more volumes in the snapshot to be the active volumes in the on-prem ONTAP cluster. In an embodiment, a REST API may be used to restore the backup snapshot. The API may be a NetApp ONTAP REST API, e.g., PATCH/storage/volumes/{uuid}. This step may be repeated when there are multiple volumes in the backup snapshot.

Next, at step 2012, the datastore supported by the restored volume in the on-prem ONTAP cluster 300 is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “CreateNasDatastore” may be used to mount the datastore.

Next, at step 2014, the VMs in the datastore are registered with the vCenter module 544 in the on-prem computing system 102. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 2016, the SnapMirror relationship is reversed so that the previous source volume in the VMC on AWS with FSxN service 104-3 is now the destination volume for replication and the previous destination volume in the on-prem computing system 102 is now the source volume for replication. This process may be executed by creating a new SnapMirror relationship between the on-prem ONTAP cluster 300 and the VMC FSxN ONTAP cluster 1608 to replicate data from the on-prem ONTAP cluster to the VMC FSxN ONTAP cluster. In an embodiment, a REST API is used to reverse the SnapMirror relationship. The API may be a NetApp ONTAP REST API, e.g., POST/snapmirror/relationships.

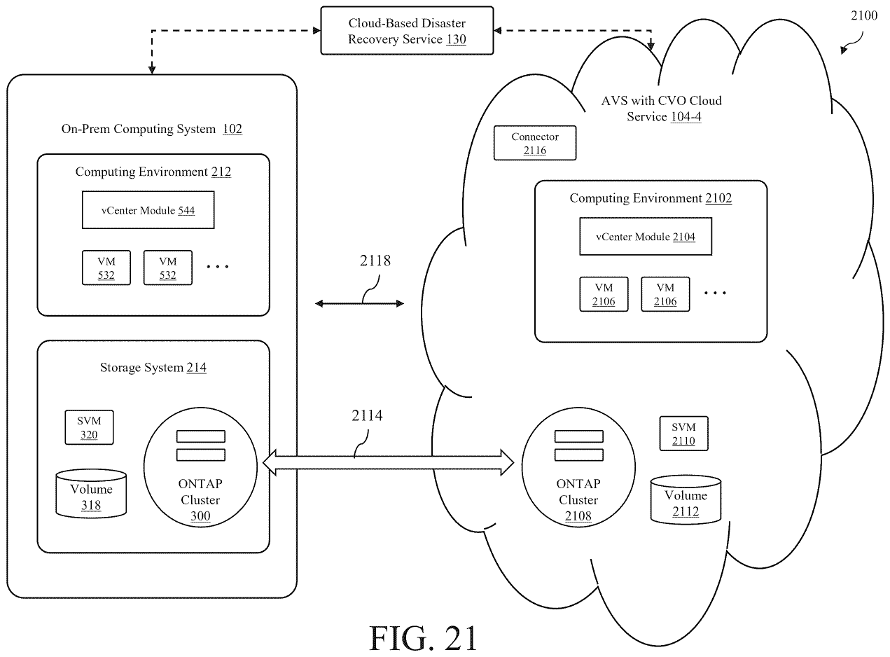

Turning now to FIG. 21, a disaster recovery system 2100 in the distributed computing system 100 formed by the primary site 102 and a secondary site 104-4 of the secondary sites 104 in which the primary site 102 is an on-prem computing system and the secondary site 104-4 is an Azure VMware Solution (AVS) with Cloud Volumes ONTAP (CVO) cloud service in accordance with an embodiment of the disclosure. The AVS with CVO cloud service can be viewed as a cloud-hosted virtualized computing environment coupled to a software-defined storage system executing within the cloud environment. In FIG. 21, the computing environment 212 of the on-prem computing system 102 is shown with only the cluster management center 544 in the form of a vCenter module and the VMs 532. In addition, the storage system 214 of the on-prem computing system 102 is shown with only the ONTAP cluster 300, a representative volume 318 and a representative SVM 320. The on-prem computing system 102 may be used as a protected site and the AVS with CVO cloud service 104-4 may be used as a backup site, or vice versa. A connection 2118 between the on-prem computing system 102 and the AVS with CVO cloud service 104-4 is used for communication. In an embodiment, the connection 2118 may be ExpressRoute Global Reach. However, in other embodiments, another type of connection may be used to connect the on-prem computing system 102 to the AVS with CVO cloud service 104-4.

As shown in FIG. 21, in the AVS with CVO cloud service 104-4, a computing environment 2102, e.g., a VMware vSphere environment, may be created or deployed. The computing environment 2102 may be used to support a vCenter module 2104 and VMs 2106. An ONTAP cluster 2108 may also be created or deployed in the AVS with CVO cloud service 104-4. The ONTAP cluster 2108 may be used to support one or more SVMs 2110 and one or more volumes 2112. The ONTAP cluster 2108 (referred to herein as “the CVO ONTAP cluster”) may establish a SnapMirror relationship 2114 with the ONTAP cluster 300 in the on-prem computing system 102 (referred to herein as the “on-prem ONTAP cluster”). The SnapMirror relationship may be a replication connection from the on-prem ONTAP cluster to the CVO ONTAP cluster or vice versa.

The cloud-based disaster recovery service 130 operates to orchestrate disaster recovery operations between the on-prem computing system 102 and the AVS with CVO cloud service 104-4 using a connector 2116, which can be deployed in the AVS with CVO cloud service, as illustrated in FIG. 21, or deployed in the on-prem computing system 102. As described below, the connector is used to discover compute and storage details of the on-prem computing system 102 and the AVS with CVO cloud service 104-4. After the discovery, various disaster recovery operations, such as test failover, failover and failback processes, can be performed.

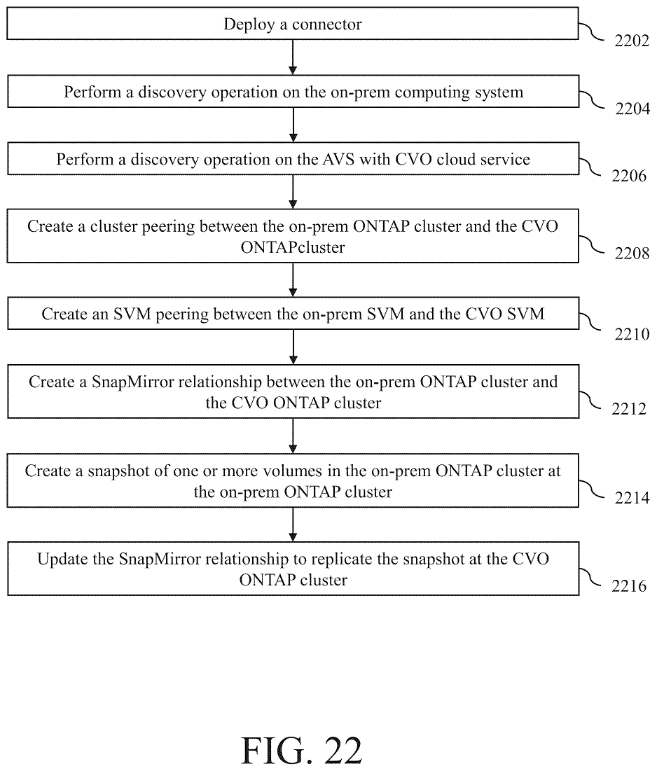

Turning now to FIG. 22, a flow diagram of a process of creating a disaster recovery plan between the on-prem computing system 102 and the AVS with CVO cloud service 120 accordance with an embodiment of the disclosure is shown. In an embodiment, this process also includes creating one or more backups of the ONTAP cluster in the on-prem computing system. After creating the disaster recovery plan, various disaster recovery processes can be executed between the on-prem computing system and the AVS with CVO cloud service, such as test failover, failover and failback, which are described below. This process is described with references to FIG. 21.

The process begins at step 2202, where the connector 2116 is deployed by the cloud-based disaster recovery service 130 in the disaster recovery system 2100. The connector may be deployed at the on-prem computing system 102 or the AVS with CVO cloud service 104-4. In an embodiment, the connector may be deployed as a VM that is configured or programmed to execute tasks related to disaster recovery operations. In another embodiment, the connector may be deployed as a service or an application.

Next, at step 2204, a discovery operation is performed on the on-prem computing system 102 by the connector 2116. The discovery operation on the on-prem computing system may be initiated by calls being made to the connector by the cloud-based disaster recovery service 130. In response, the connector executes the discovery operation to retrieve datastore and storage footprint details, and work environment and SVM details, as well as any storage replication relationships, such as SnapMirror relationships. In addition, export path or LUN path received from datastore discovery may also be retrieved. If NFS is being used in the on-prem computing system, volume details matching the junction/export path may be retrieved. If SAN is being used in the on-prem computing system, LUN details matching the LUN path and serial number may be retrieved. In an embodiment, the cloud-based disaster recovery service may register the volumes/LUNs in a database and generate unique storage IDs corresponding to the volumes/LUNs.

Next, at step 2206, a discovery operation is performed on the AVS with CVO cloud service 104-4 by the connector 2116. The discovery operation on the AVS with CVO cloud service may also be initiated by calls being made to the connector by the cloud-based disaster recovery service. In response, the connector executes the discovery operation to retrieve the AVS with CVO cloud service details, which may include its resources, datastore and storage footprint details, and work environment and SVM details. As an example, the identified AVS resources may include, but not limited, any vCenter instances running inside the AVS with CVO cloud service, hosts and networking details, such as NSX segments and VLANs.

Next, at step 2208, a cluster peering between the on-prem ONTAP cluster 300 and the CVO ONTAP cluster 2108 is established. Cluster peering is the process of establishing a trusted, authenticated communication channel between two ONTAP clusters. In an embodiment, the cluster peering involves instructing the CVO ONTAP cluster to establish the cluster peering by the cloud-based disaster recovery service 130. In response, a cluster peering request API is transmitted to the on-prem ONTAP cluster from the CVO ONTAP cluster. When the cluster peering request is accepted by the on-prem ONTAP cluster, the cluster peering between the on-prem ONTAP cluster and the CVO ONTAP cluster is established, which results in exchange of intercluster LIFs for every node in both clusters. If there is no existing CVO ONTAP cluster in the AVS with CVO cloud service, a new CVO ONTAP cluster is deployed in the AVS with CVO cloud service by the connector 2116. In an embodiment, a REST API is used to establish the cluster peering. The API may be a NetApp ONTAP REST API, e.g., POST/cluster/peers.

Next, at step 2210, an SVM peering between the SVM 320 in the on-prem ONTAP storage system 214 (“the on-prem SVM”) and the SVM 2110 in the AVS with CVO cloud service 104-4 (“the CVO SVM”) is established by the cloud-based disaster recovery service 130. In an embodiment, the SVM peering involves instructing the CVO ONTAP cluster to establish the SVM peering by the cloud-based disaster recovery service. In response, an SVM peering request API is transmitted to the on-prem ONTAP cluster by the CVO ONTAP cluster. When the SVM peering request is accepted by the on-prem ONTAP cluster, the SVM peering between the on-prem SVM and the CVO SVM is established. If there is no existing CVO SVM in the AVS with CVO cloud service, a new CVO SVM is deployed in the AVS with CVO cloud service by the connector 2116. In an embodiment, a REST API is used to establish the SVM peering. The API may be a NetApp ONTAP REST API, e.g., POST/svm/peers.

Next, at step 2212, a SnapMirror relationship, e.g., 2114, is created between the on-prem ONTAP cluster 300 and the CVO ONTAP cluster 2108 to replicate data from the on-prem ONTAP cluster to the CVO ONTAP cluster. It is assumed here that this step is being performed because no storage replication relationship is found between the on-prem ONTAP cluster 300 and the CVO ONTAP cluster 2108. The SnapMirror relationship may be created using a SnapMirror create command for a source and a destination endpoint. In an embodiment, a REST API is used to create the SnapMirror relationship. The API may be a NetApp ONTAP REST API, e.g., POST/snapmirror/relationships.

Next, at step 2214, a snapshot of one or more volumes in the on-prem ONTAP cluster 300 is created at the on-prem ONTAP cluster. In an embodiment, a REST API is used to create the snapshot. The API may be a NetApp ONTAP REST API, e.g., POST/storage/volumes/{volume.uuid}/snapshots.

Next, at step 2216, the SnapMirror relationship is updated to replicate the snapshot at the CVO ONTAP cluster 2108. In an embodiment, a REST API is used to create the snapshot. The API may be a NetApp ONTAP REST API, e.g., POST/snapmirror/relationships/{relationship.uuid}/transfers.

Consequently, a disaster recovery plan is created between the on-prem computing system 102 and the AVS with CVO cloud service 104-4, as well as a backup snapshot, which can then be used to execute test failover, failover and failback operations. Additional backup snapshots of the on-prem ONTAP cluster may be created at different points in time. This disaster recovery plan may be saved by the cloud-based disaster recovery service 130 and added to a list of disaster recovery plans, which may be maintained by the cloud-based disaster recovery service. One of more of the plans from the list of disaster recovery plans may be selected to perform a disaster recovery operation, such as test failover, failover and failback operations, as well as migration operations.

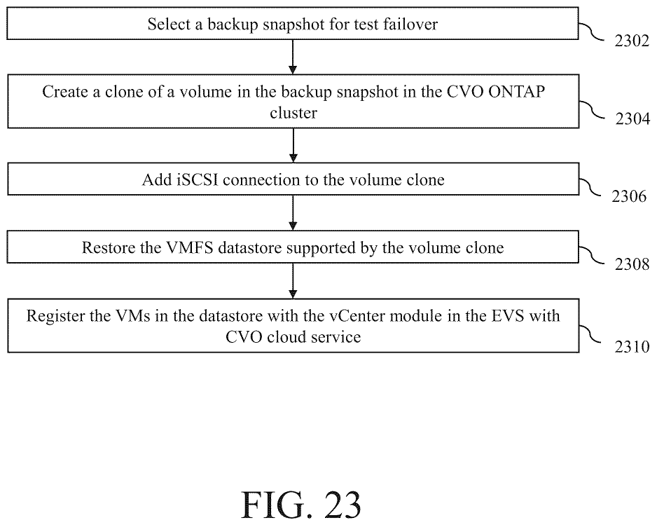

Turning now to FIG. 23, a flow diagram of a process of executing a test failover from the on-prem computing system 102 to the AVS with CVO cloud service 104-4 in accordance with an embodiment of the disclosure is shown. This process is described with references to FIG. 21.

The process begins at step 2302, where a backup snapshot is selected for test failover by the cloud-based disaster recovery service 130. The backup snapshot is a snapshot of one or more volumes from the on-prem ONTAP cluster 300, which has been replicated in the CVO ONTAP cluster 2108. In an embodiment, an administrator may use the UI for the cloud-based disaster recovery service to manually enter the backup snapshot for the test failover for a selected disaster recovery plan.

Next, at step 2304, a clone of a volume in the backup snapshot is created in the CVO ONTAP cluster 2108. The clone of the volume may be created by issuing a volume clone command that specifies the volume in the backup snapshot. In an embodiment, a REST API is used to create the volume clone. The API may be a NetApp ONTAP REST API, e.g., POST/storage/volumes. This step may be repeated when there are multiple volumes in the backup snapshot.

Next, at step 2306, iSCSI connection is added to the volume clone to allow the AVS with CVO cloud service 104-4 to connect to the volume clone. In an embodiment, a script cmdlet from AVS PowerCLI based Automation Tools for Administrators may be used to add the iSCSI connection to the volume clone. As an example, a script cmdlet named “Microsoft. AVS. VMFS. psm133” may be used. This step may be repeated when there are multiple volumes in the backup snapshot that need to be cloned.

Next, at step 2308, the VMFS datastore supported by the volume clone is restored in the CVO ONTAP cluster 2108 so that the VMFS datastore can be accessed and used to store data. In an embodiment, a script cmdlet from AVS PowerCLI based Automation Tools for Administrators may be used to restore the VMFS datastore. As an example, a tool named “Microsoft. AVS. VMFS. psm1L577” may be used.

Next, at step 2310, the VMs in the VMFS datastore are registered with the vCenter module 2104 in the AVS with CVO cloud service 104-4, which completes the test failover. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

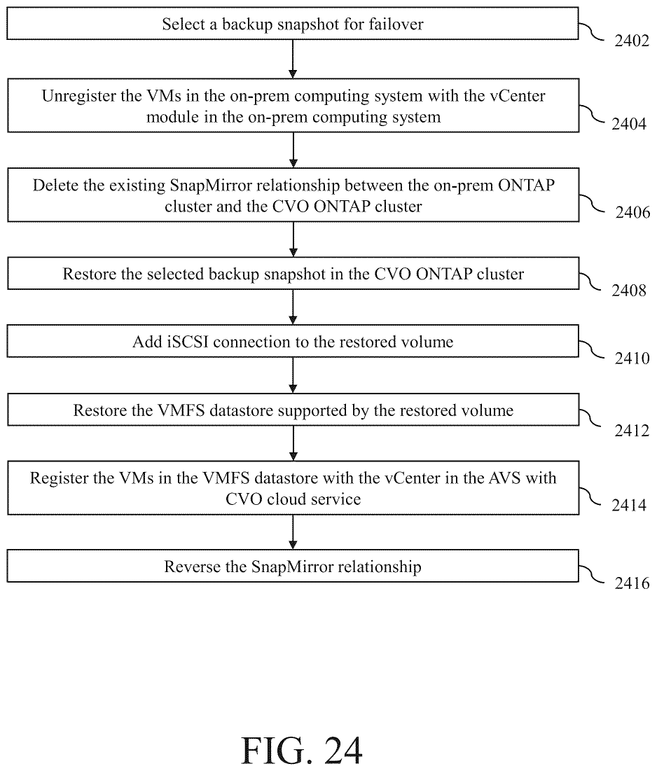

Turning now to FIG. 24, a flow diagram of a process of executing a failover from the on-prem computing system 102 to the AVS with CVO cloud service 104-4 in accordance with an embodiment of the disclosure is shown. This process is described with references to FIG. 21.

The process begins at step 2402, where a backup snapshot is selected for failover by the cloud-based disaster recovery service 130. In an embodiment, an administrator may use the UI for the cloud-based disaster recovery service to manually enter the backup snapshot for the failover for a selected disaster recovery plan.

Next, at step 2404, the VMs in the on-prem computing system 102 are unregistered with the vCenter module 544 in the on-prem computing system. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

Next, at step 2406, the existing SnapMirror relationship between the on-prem ONTAP cluster 300 and the CVO ONTAP cluster 2108 is deleted by the cloud-based disaster recovery service 130. The existing SnapMirror relationship may be deleted using a snapmirror delete command that specifies the particular SnapMirror relationship. In an embodiment, a REST API is used to delete the existing SnapMirror relationship. The API may be a NetApp ONTAP REST API, e.g., DELETE/snapmirror/relationships/{uuid}.

Next, at step 2408, the selected backup snapshot is restored in the CVO ONTAP cluster 2108 by the cloud-based disaster recovery service 130. The selected backup snapshot may be restored using a snapshot restore command that specifies the particular backup snapshot. The snapshot restore command brings one or more volumes in the snapshot to be the active volumes in the CVO ONTAP cluster. In an embodiment, a REST API is used to restore the backup snapshot. The API may be a NetApp ONTAP REST API, e.g., PATCH/storage/volumes/{uuid}. This step may be repeated when there are multiple volumes in the backup snapshot.

Next, at step 2410, iSCSI connection is added to the restored volume to allow the AVS with CVO cloud service 104-4 to connect to the restored volume. In an embodiment, the script cmdlet from AVS PowerCLI based Automation Tools for Administrators, e.g., the “Microsoft. AVS. VMFS. psm133” tool, may be used to add the iSCSI connection to the volume clone.

Next, at step 2412, the VMFS datastore supported by the restored volume is restored in the CVO ONTAP cluster 2108 so that the VMFS datastore can be accessed and used to store data. In an embodiment, the script cmdlet from AVS PowerCLI based Automation Tools for Administrators, e.g., the “Microsoft. AVS. VMFS. psm1L577” tool, may be used to restore the VMFS datastore.

Next, at step 2414, the VMs in the VMFS datastore are registered with the vCenter module 2104 running in the AVS with CVO cloud service 104-4. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 2416, the SnapMirror relationship is reversed so that the previous source volume in the on-prem computing system 102 is now the destination volume for replication and the previous destination volume in the AVS with CVO cloud service 104-4 is now the source volume for replication. This process may be executed by creating a new SnapMirror relationship between the on-prem ONTAP cluster and the CVO ONTAP cluster to replicate data from the CVO ONTAP cluster to the on-prem ONTAP cluster. In an embodiment, a REST API is used to reverse the SnapMirror relationship. The API may be a NetApp ONTAP REST API, e.g., POST/snapmirror/relationships.

Once the VMs have been registered, the VMs in the on-prem computing system 102 have been migrated to the AVS with CVO cloud service 104-4 using the backup snapshot. However, in order to complete the failover process, the SnapMirror relationship is reversed so that the on-prem computing system can be used for future failover.

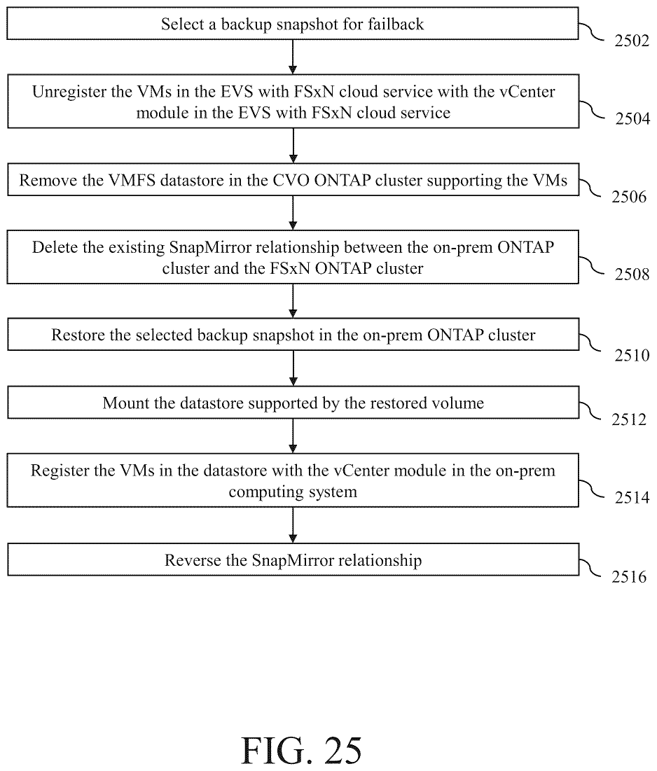

Turning now to FIG. 25, a flow diagram of a process of executing a failback from the AVS with CVO cloud service 104-4 to the on-prem computing system 102 in accordance with an embodiment of the disclosure is shown. This process is described with references to FIG. 21.

The process begins at step 2502, a backup snapshot is selected for failback by the cloud-based disaster recovery service 130. In an embodiment, an administrator may use the UI for the cloud-based disaster recovery service to manually enter the backup snapshot for the failback for a selected disaster recovery plan.

Next, at step 2504, the VMs in the AVS with CVO service 104-4 are unregistered with the vCenter module 2104 in the AVS with CVO service 104-4. In an embodiment, one or more APIs or scripts may be used to unregister the VMs. For example, one or more automation scripts or tools using Go library for VMware vSphere APIs may be used to unregister the VMs. As an example, an automation script called “unregister” may be used to register the VMs.

At step 2506, the VMFS datastore in the CVO ONTAP cluster 2108 supporting the VMs is removed so that the VMFS datastore can no longer be accessed and used to store data. In an embodiment, a script cmdlet from AVS PowerCLI based Automation Tools for Administrators may be used to remove the VMFS datastore. As an example, a tool named “Microsoft. AVS. VMFS. psm1L577” may be used.

Next, at step 2508, the existing SnapMirror relationship from the CVO ONTAP cluster 2108 to the on-prem ONTAP cluster 300 is deleted by the cloud-based disaster recovery service 130. In an embodiment, a REST API is used to delete the existing SnapMirror relationship. The API may be a NetApp ONTAP REST API, e.g., DELETE/snapmirror/relationships/{uuid}.

Next, at step 2510, the selected backup snapshot is restored in the on-prem ONTAP cluster 300 by the cloud-based disaster recovery service 130. The selected backup snapshot may be restored using a snapshot restore command that specifies the particular backup snapshot. The snapshot restore command brings one or more volumes in the snapshot to be the active volumes in the on-prem ONTAP cluster. The API may be a NetApp ONTAP REST API, e.g., PATCH/storage/volumes/{uuid}. This step may be repeated when there are multiple volumes in the backup snapshot.

Next, at step 2512, the datastore supported by the restored volume in the on-prem ONTAP cluster 300 is mounted so that the datastore can be accessed and used to store data. In an embodiment, one or more APIs or scripts may be used to mount the datastore. For example, one or more automation scripts or tools using Go library for VMware vSphere APIs may be used to mount the datastore. As an example, an automation script called “Restore-VmfsVolume” may be used to mount the datastore.

Next, at step 2514, the VMs in the datastore are registered with the vCenter module 544 in the on-prem computing system 102. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 2516, the SnapMirror relationship is reversed so that the previous source volume in the AVS with CVO service 104-4 is now the destination volume for replication and the previous destination volume in the on-prem computing system 102 is now the source volume for replication. This process may be executed by creating a new SnapMirror relationship between the on-prem ONTAP cluster 300 and the CVO ONTAP cluster 2108 to replicate data from the on-prem ONTAP cluster to the CVO ONTAP cluster. In an embodiment, a REST API is used to reverse the SnapMirror relationship. The API may be a NetApp ONTAP REST API, e.g., POST/snapmirror/relationships.

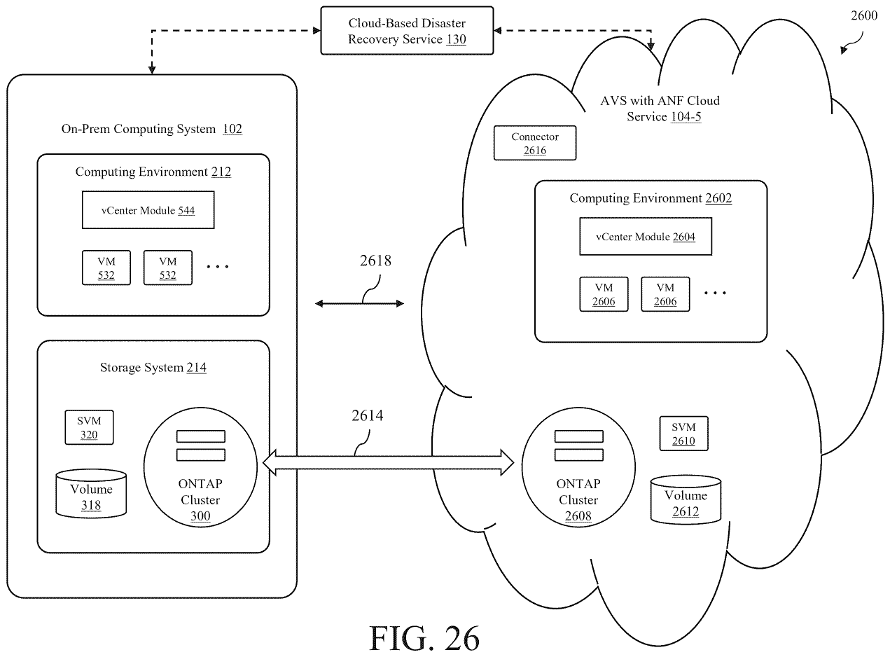

Turning now to FIG. 26, a disaster recovery system 2600 in the distributed computing system 100 formed by the primary site 102 and a secondary site 104-5 of the secondary sites 104 in which the primary site 102 is an on-prem computing system and the secondary site 104-5 is an AVS with Azure NetApp Files (ANF) cloud service in accordance with an embodiment of the disclosure is shown. The AVS with ANF cloud service can be viewed as a cloud-hosted virtualized computing environment coupled to a native cloud file storage service provided as a platform service. In FIG. 26, the computing environment 212 of the on-prem computing system 102 is shown with only the cluster management center 544 in the form of a vCenter module and the VMs 532. In addition, the storage system 214 of the on-prem computing system 102 is shown with only the ONTAP cluster 300, a representative volume 318 and a representative SVM 320. The on-prem computing system 102 may be used as a protected site and the AVS with ANF cloud service 104-5 may be used as a backup site, or vice versa. A connection 2618 between the on-prem computing system 102 and the AVS with ANF cloud service 104-5 may be ExpressRoute Global Reach. However, in other embodiments, another type of connection may be used to connect the on-prem computing system 102 to the AVS with ANF cloud service 104-5.

As shown in FIG. 26, in the AVS with ANF cloud service 104-5, a computing environment 2602, e.g., a VMware vSphere environment, may be created or deployed. The computing environment 2602 may be used to support a vCenter module 2604 and VMs 2606. An ONTAP cluster 2608 may also be created or deployed in the AVS with ANF cloud service 104-5. The ONTAP cluster 2608 may be used to support one or more SVMs 2610 and one or more volumes 2612. The ONTAP cluster 2608 (referred to herein as “the ANF ONTAP cluster”) may establish a SnapMirror relationship 2614 with the ONTAP cluster 300 in the on-prem computing system 102 (referred to herein as the “on-prem ONTAP cluster”). The SnapMirror relationship may be a replication connection from the on-prem ONTAP cluster to the ANF ONTAP cluster or vice versa.

The cloud-based disaster recovery service 130 operates to orchestrate disaster recovery operations between the on-prem computing system 102 and the AVS with ANF cloud service 104-5 using a connector 2616, which can be deployed in the AVS with ANF cloud service, as illustrated in FIG. 26, or deployed in the on-prem computing system 102. As described below, the connector is used to discover compute and storage details of the on-prem computing system 102 and the AVS with ANF cloud service 104-5. After the discovery, a VM migration operation can be executed.

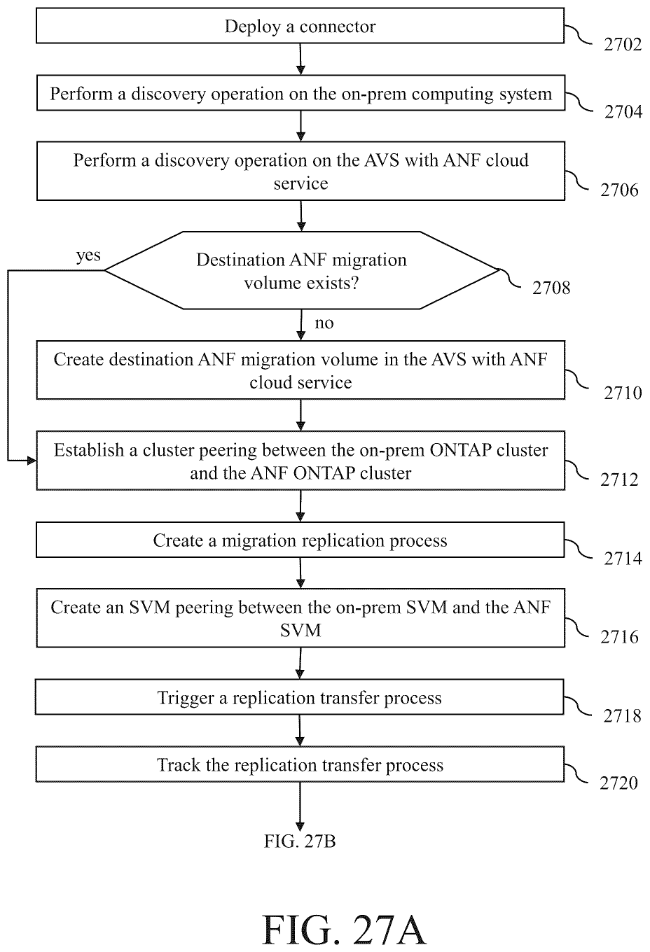

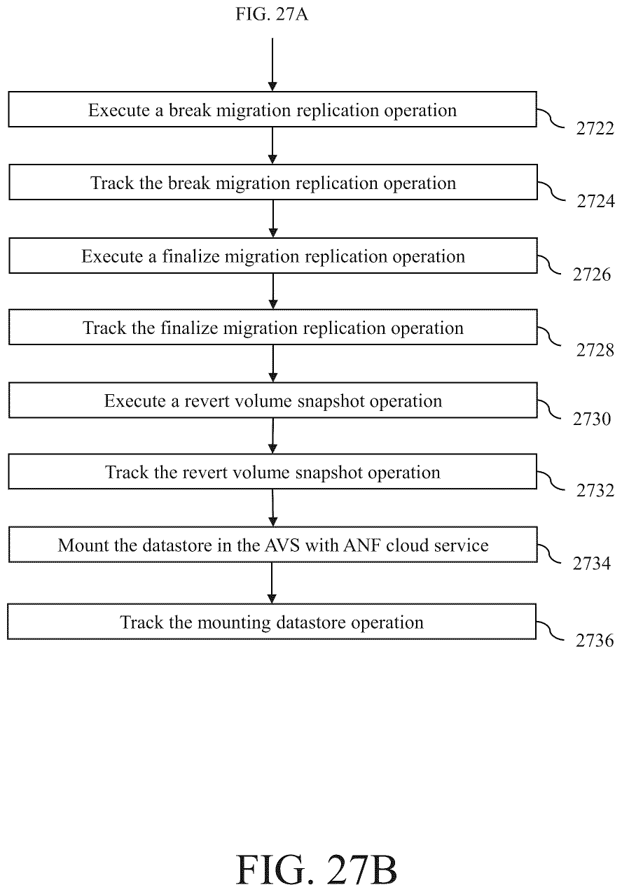

Turning now to FIGS. 27A and 27B, a flow diagram of a process of migrating VMs from the on-prem computing system 102 to the AVS with ANF cloud service 104-5 in accordance with an embodiment of the disclosure is shown. This process includes a replication plan workflow, a backup workflow and a migrate workflow. The replication plan workflow covers the creation of destination ANF migration volumes, establishing cluster and SVM peering between on-prem ONTAP cluster 300 and the ANF ONTAP cluster 2608, and setting up replication (e.g., SnapMirror relationship) between source ONTAP volumes and destination ANF volumes. The Backup workflow is designed to facilitate the creation and management of backups for data stored in the storage system 214 and Azure NetApp Files. This workflow ensures data protection, retention, and recovery capabilities, providing a robust backup solution for enterprise environments. The Migrate workflow is designed to facilitate the seamless migration of VMs and associated data from the on-prem vCenter environments to Azure VMware Solution (AVS) using Azure NetApp Files. This workflow ensures data consistency, integrity, and minimal downtime during the migration process. This process is described with references to FIG. 26.

The replication plan workflow begins at step 2702, where the connector 2616 is deployed by the cloud-based disaster recovery service 130 in the disaster recovery system 2600. The connector may be deployed at the on-prem computing system 102 or the AVS with ANF cloud service 104-5. In an embodiment, the connector may be deployed as a VM that is configured or programmed to execute tasks related to disaster recovery operations. In another embodiment, the connector may be deployed as a service or an application.

Next, at step 2704, a discovery operation is performed on the on-prem computing system 102 by the connector 2616. The discovery operation on the on-prem computing system may be initiated by calls being made to the connector by the cloud-based disaster recovery service 130. In response, the connector executes the discovery operation to retrieve datastore and storage footprint details, and work environment and SVM details, as well as any storage replication relationships, such as SnapMirror relationships. In addition, export path or LUN path received from datastore discovery may also be retrieved. If NFS is being used in the on-prem computing system, volume details matching the junction/export path may be retrieved. If SAN is being used in the on-prem computing system, LUN details matching the LUN path and serial number may be retrieved. In an embodiment, the cloud-based disaster recovery service may register the volumes/LUNs in a database and generate unique storage IDs corresponding to the volumes/LUNs.

Next, at step 2706, a discovery operation is performed on the AVS with ANF cloud service 104-5 by the connector 2616. The discovery operation on the AVS with ANF cloud service may also be initiated by calls being made to the connector by the cloud-based disaster recovery service. In response, the connector executes the discovery operation to retrieve the AVS with ANF cloud service details, which may include its resources, datastore and storage footprint details, and work environment and SVM details. As an example, the identified AVS resources may include, but not limited, any vCenter instances running inside the AVS with ANF cloud service, hosts and networking details, such as NSX segments and VLANs.

Next, at step 2708, a check is performed to determine whether a destination ANF migration volume exists in the AVS with ANF cloud service 104-5. In an embodiment, the check is made to determine whether the destination ANF migration volume determination exists in a specified account and capacity pool in the AVS with ANF cloud service.

If the ANF migration volume already exists in the AVS with ANF cloud service 104-5, the process proceeds to step 2712. However, if the ANF migration volume does not exist, a destination ANF migration volume is created in the AVS with ANF cloud service by the connector 2616, at step 2710. In an embodiment, an API call may be used to create the destination ANF migration volume in the AVS with ANF cloud service. As an example, an API called “Volume create” in Azure management repository may be used.

Next, step 2712, a cluster peering is established between the on-prem ONTAP cluster 300 and the ANF ONTAP cluster 2608. As part of this step, inter-cluster LIFs are fetched from the on-prem cluster 300 and the cluster peering is initiated on the ANF ONTAP cluster. In an embodiment, a peering API is executed on the source ONTAP cluster. As an example, an API called “peer external cluster” in Azure management repository may be used.

Next, at step 2714, a migration replication process is created. The migration replication process includes starting SVM peering and creating a SnapMirror relationship (assuming no SnapMirror relationship was discovered). The migration replication process includes tracking the async job of creating the SnapMirror relationship and executing a SVM peering command on the external ONTAP. In an embodiment, an API is used to create the migration replication process. As an example, an API called “get operationresults” in Azure management repository may be used.

Next, at step 2716, an SVM peering is established between the SVM 320 running in the on-prem computing system 102 (“on-prem SVM”) and the SVM 2610 running in the AVS with ANF cloud service 104-5 (“ANF SVM”). This step includes fetching the SVM peering universally unique identifier (UUID) and setting the state to “peered” and tracking the job to determine the operation status. In an embodiment, an API is used to establish the SVM peering. As an example, an API called “vserver peer accept” in Azure management repository may be used.

At this point, the replication plan workflow is complete and the backup flow begins. The backup workflow involves taking snapshots of on-prem ONTAP storage, transferring these snapshots to the ANF migration volumes, and performing retention of snapshots based on predefined policies. The backup workflow begins at step 2718, where a replication transfer process is triggered. This step initiates the transfer of snapshots from the on-premises ONTAP storage to the ANF migration volume. This step ensures that the latest data is captured and transferred to the target environment. In an embodiment, an API is used to create the migration replication process. As an example, an API called “performReplicationTransfer” in Azure management repository may be used.

Next, at optional step 2720, the replication transfer process, which may be an asynchronous job, is tracked. The purpose of this step is to monitor the progress and status of the replication transfer job. This step ensures that the replication transfer is completed successfully and addresses any issues that may arise. In an embodiment, an API is used to track the replication transfer process. As an example, an API called “get operationresults” in Azure management repository may be used.

At this point, the backup workflow is complete and the migrate workflow begins. The migrate workflow involves selecting a volume snapshot, breaking the SnapMirror relationship between the source on-prem ONTAP volume and the destination ANF migration volume, finalizing the external replication, reverting the volume snapshot and mounting the datastore in the AVS with ANF cloud service 104-5.

The migrate workflow begins at step 2722, where a break migration replication operation is executed. The purpose of this step is to terminate the SnapMirror relationship between the source and destination volumes. This step is executed with the force break replication option, which ignores any transfer in progress during the break replication. In an embodiment, an API is used to execute the break migration replication operation. As an example, an API called “break replication” in Azure management repository may be used.

Next, at optional step 2724, the break migration replication operation is tracked. The purpose of this step is to monitor the progress and status of the break replication job. This step ensures that the replication break is completed successfully and addresses any issues that may arise. In an embodiment, an API is used to track the break migration replication operation. As an example, an API called “get operationresults” in Azure management repository may be used.

Next, at step 2726, a finalize migration replication operation is executed. This step deletes the migration replication and cleans up any remaining replication artifacts. This step ensures that the migration is finalized and that the target environment is ready for use. In an embodiment, an API is used to execute the finalize migration replication operation. As an example, an API called “finalizeExternalReplication” in Azure management repository may be used.

Next, at step 2728, the finalize migration replication operation, which may be an asynchronous job, is tracked. The purpose of this step is to monitor the progress and status of the finalize migration replication job. This step ensures that the finalization is completed successfully and addresses any issues that may arise. In an embodiment, an API is used to execute the finalize migration replication operation. As an example, an API called “get operationresults” in Azure management repository may be used.

Next, at step 2730, a revert volume snapshot operation is executed. The purpose of this step is to revert the destination volume to the selected snapshot from the cloud-based disaster recovery service 130. This step ensures that the target volume reflects the state of the selected snapshot. In an embodiment, an API is used to execute the revert volume snapshot operation. As an example, an API called “revert volume” in Azure management repository may be used.

Next, at optional step 2732, the revert volume snapshot operation, which may be an asynchronous job, is tracked. The purpose of this step is to monitor the progress and status of the revert volume snapshot job. This step ensures that the revert operation is completed successfully and addresses any issues that may arise. In an embodiment, an API is used to track the revert volume snapshot operation. As an example, an API called “get operationresults” in Azure management repository may be used.

Next, at step 2734, the datastore is mounted in the AVS with ANF cloud service 104-5. The purpose of this step is to connect the reverted ANF volumes to the AVS with ANF cloud service 104-5 as datastores. This step allows the VMs to be registered and powered on in the target environment, i.e., the AVS with ANF cloud service 104-5. In an embodiment, an API is used to mount the datastore in the AVS with ANF cloud service. As an example, an API called “create datastore” in Azure management repository may be used.

Next, at optional step 2736, the mounting datastore operation, which may be an asynchronous job, is tracked. The purpose of this step is to monitor the progress and status of the mounting datastore job. This step ensures that the datastore is mounted successfully and addresses any issues that may arise. In an embodiment, an API is used to track the mounting datastore operation. As an example, an API called “get operationresults” in Azure management repository may be used.

In addition to disaster recovery between on-prem computing systems and cloud services, the cloud-based disaster recovery service 130 may also provide disaster recovery between two cloud services. This cloud-to-cloud disaster recovery enables organizations to protect their cloud-based workloads by replicating data and VMs between cloud services in different regions, providing geographic redundancy and protection against regional outages.

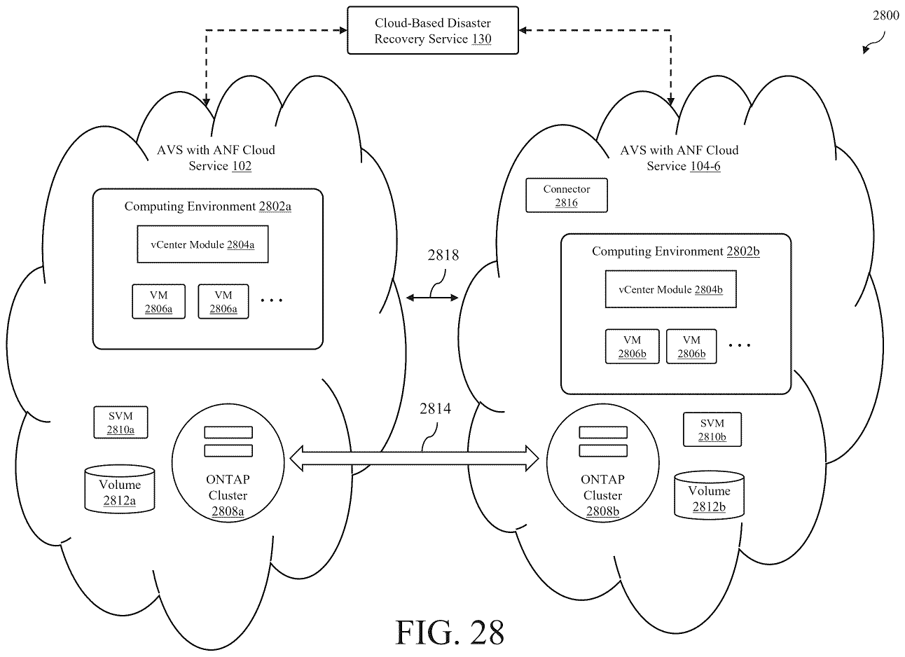

Turning now to FIG. 28, a cloud-to-cloud disaster recovery system 2800 in the distributed computing system 100 formed by the primary site 102 and a secondary site 104-6 of the secondary sites 104 in which the primary site 102 is a first AVS with ANF cloud service and the secondary site 104-6 is a second AVS with ANF cloud service in accordance with an embodiment of the disclosure is shown. The first AVS with ANF cloud service 102 and the second AVS with ANF cloud service 104-6 may be located in different Azure regions, such as different geographic locations within the Azure cloud platform. The first AVS with ANF cloud service 102 may be used as a protected site and the second AVS with ANF cloud service 104-6 may be used as a backup site, or vice versa.

In FIG. 28, the first AVS with ANF cloud service 102 includes a computing environment 2802a and an ONTAP cluster 2808a. The computing environment 2802a is shown with a vCenter module 2804a and VMs 2806a. The ONTAP cluster 2808a supports a volume 2812a and an SVM 2810a. Similarly, the second AVS with ANF cloud service 104-6 includes a computing environment 2802b and an ONTAP cluster 2808b. The computing environment 2802b is shown with a vCenter module 2804b and VMs 2806b. The ONTAP cluster 2808b supports a volume 2812b and an SVM 2810b.

A connection 2818 provides communication between the first AVS with ANF cloud service 102 and the second AVS with ANF cloud service 104-6. The connection 2818 may be implemented using Azure's cross-region networking capabilities, such as Azure Virtual Network peering or Azure ExpressRoute Global Reach, or another type of network connection that enables communication between the two AVS with ANF cloud services in different Azure regions.

The ONTAP cluster 2808b in the second AVS with ANF cloud service 104-6 (referred to herein as “the second ANF ONTAP cluster”) may establish a SnapMirror relationship 2814 with the ONTAP cluster 2808a in the first AVS with ANF cloud service 102 (referred to herein as “the first ANF ONTAP cluster”). The SnapMirror relationship 2814 may leverage ANF Cross Region Replication to replicate data from the first ANF ONTAP cluster to the second ANF ONTAP cluster or vice versa.

The cloud-based disaster recovery service 130 operates to orchestrate disaster recovery operations between the first AVS with ANF cloud service 102 and the second AVS with ANF cloud service 104-6 using a connector 2816, which can be deployed in the second AVS with ANF cloud service 104-6, as illustrated in FIG. 28, or deployed in the first AVS with ANF cloud service 102. As described below, the connector is used to discover compute and storage details of the first AVS with ANF cloud service 102 and the second AVS with ANF cloud service 104-6. After the discovery, various disaster recovery operations, such as test failover, failover and failback processes, can be performed.

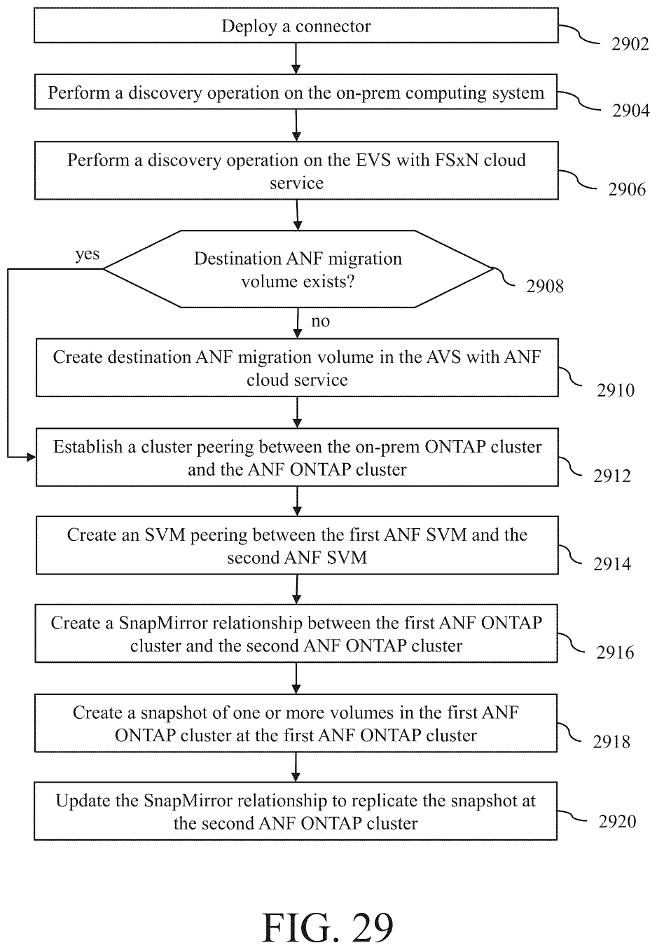

Turning now to FIG. 29, a flow diagram of a process of creating a disaster recovery plan between the first AVS with ANF cloud service 102 and the second AVS with ANF cloud service 104-6 in accordance with an embodiment of the disclosure is shown. In an embodiment, this process also includes creating one or more backups of the ONTAP cluster 2808a in the first AVS with ANF cloud service 102. After creating the disaster recovery plan, various disaster recovery processes can be executed between the first AVS with ANF cloud service 102 and the second AVS with ANF cloud service 104-6, such as test failover, failover and failback, which are described below. This disaster recovery plan creation process is described with references to FIG. 28.

The process begins at step 2902, where the connector 2816 is deployed by the cloud-based disaster recovery service 130 in the cloud-to-cloud disaster recovery system 2800. The connector 2816 may be deployed at the first AVS with ANF cloud service 102 or the second AVS with ANF cloud service 104-6. In an embodiment, the connector 2816 may be deployed as a VM that is configured or programmed to execute tasks related to disaster recovery operations. In another embodiment, the connector 2816 may be deployed as a service or an application.

Next, at step 2904, a discovery operation is performed on the first AVS with ANF cloud service 102 by the connector 2816. The discovery operation on the first AVS with ANF cloud service may be initiated by calls being made to the connector by the cloud-based disaster recovery service 130. In response, the connector executes the discovery operation to retrieve datastore and storage footprint details, and work environment and SVM details, as well as any storage replication relationships, such as SnapMirror relationships. As an example, the identified AVS resources may include, but not limited, any vCenter instances running inside the first AVS with ANF cloud service, such as the vCenter module 2804a, hosts and networking details, such as NSX segments and VLANs. In an embodiment, the cloud-based disaster recovery service may register the volumes in a database and generate unique storage IDs corresponding to the volumes.

Next, at step 2906, a discovery operation is performed on the second AVS with ANF cloud service 104-6 by the connector 2816. The discovery operation on the second AVS with ANF cloud service may also be initiated by calls being made to the connector by the cloud-based disaster recovery service 130. In response, the connector executes the discovery operation to retrieve the second AVS with ANF cloud service details, which may include its resources, datastore and storage footprint details, and work environment and SVM details. As an example, the identified AVS resources may include, but not limited, any vCenter instances running inside the second AVS with ANF cloud service, such as the vCenter module 2804b, hosts and networking details, such as NSX segments and VLANs.

Next, at step 2908, a check is performed to determine whether a destination ANF volume exists in the second AVS with ANF cloud service 104-6. In an embodiment, the check is made to determine whether the destination ANF volume exists in a specified account and capacity pool in the second AVS with ANF cloud service.

If the ANF volume already exists in the second AVS with ANF cloud service 104-6, the process proceeds to step 2912. However, if the ANF volume does not exist, a destination ANF volume is created in the second AVS with ANF cloud service by the connector 2816, at step 2910. In an embodiment, an API call may be used to create the destination ANF volume in the second AVS with ANF cloud service. As an example, an API called “Volume create” in Azure management repository may be used.

Next, at step 2912, a cluster peering is established between the first ANF ONTAP cluster 2808a and the second ANF ONTAP cluster 2808b. As part of this step, inter-cluster LIFs are fetched from the first ANF ONTAP cluster 2808a and the cluster peering is initiated on the second ANF ONTAP cluster. In an embodiment, a peering API is executed on the source ONTAP cluster. As an example, an API called “peer external cluster” in Azure management repository may be used.

Next, at step 2914, an SVM peering between the SVM 2810a in the first AVS with ANF cloud service 102 (“the first ANF SVM”) and the SVM 2810b in the second AVS with ANF cloud service 104-6 (“the second ANF SVM”) is established by the cloud-based disaster recovery service 130. This step may include fetching the SVM peering UUID and setting the state to “peered” and tracking the job to determine the operation status. In an embodiment, an API is used to establish the SVM peering. As an example, an API called “vserver peer accept” in Azure management repository may be used.

Next, at step 2916, a SnapMirror relationship, e.g., the SnapMirror relationship 2816, is created between the first ANF ONTAP cluster 2808a and the second ANF ONTAP cluster 2808b to replicate data from the first ANF ONTAP cluster to the second ANF ONTAP cluster. It is assumed here that this step is being performed because no storage replication relationship is found between the first ANF ONTAP cluster 2808a and the second ANF ONTAP cluster 2808b. The SnapMirror relationship may leverage ANF Cross Region Replication to enable data replication between the two Azure regions. In an embodiment, an API is used to create the SnapMirror relationship. As an example, an API called “create replication” in Azure management repository may be used.

Next, at step 2918, a snapshot of one or more volumes in the first ANF ONTAP cluster 2808a is created at the first ANF ONTAP cluster. In an embodiment, an API is used to create the snapshot. As an example, an API called “create snapshot” in Azure management repository may be used.

Next, at step 2920, the SnapMirror relationship is updated to replicate the snapshot at the second ANF ONTAP cluster 2808b. In an embodiment, an API is used to update the SnapMirror relationship. As an example, an API called “performReplicationTransfer” in Azure management repository may be used.

Consequently, a disaster recovery plan is created between the first AVS with ANF cloud service 102 and the second AVS with ANF cloud service 104-6, as well as a backup snapshot, which can then be used to execute test failover, failover and failback operations. Additional backup snapshots of the first ANF ONTAP cluster may be created at different points in time. This disaster recovery plan may be saved by the cloud-based disaster recovery service 130 and added to a list of disaster recovery plans, which may be maintained by the cloud-based disaster recovery service. One of more of the plans from the list of disaster recovery plans may be selected to perform a disaster recovery operation, such as test failover, failover and failback operations, as well as migration operations.

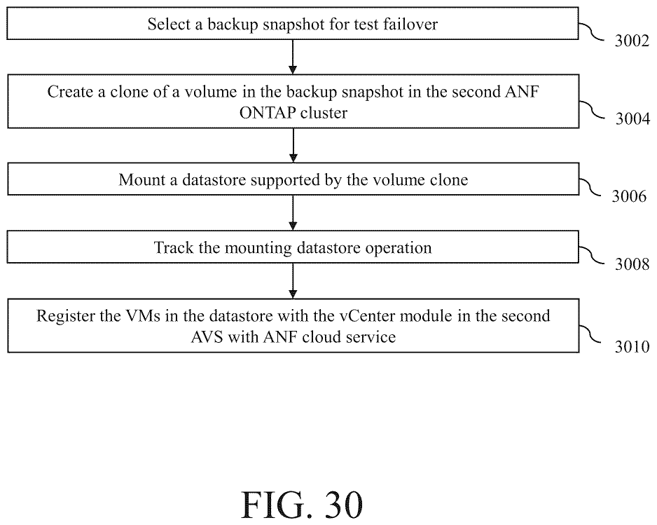

Turning now to FIG. 30, a flow diagram of a process of executing a test failover from the first AVS with ANF cloud service 102 to the second AVS with ANF cloud service 104-6 in accordance with an embodiment of the disclosure is shown. This process is described with references to FIG. 28.

The process begins at step 3002, where a backup snapshot is selected for test failover by the cloud-based disaster recovery service 130. The backup snapshot is a snapshot of one or more volumes from the first ANF ONTAP cluster 2808a, which has been replicated in the second ANF ONTAP cluster 2808b. In an embodiment, an administrator may use the UI for the cloud-based disaster recovery service to manually enter the backup snapshot for the test failover for a selected disaster recovery plan.

Next, at step 3004, a clone of a volume in the backup snapshot is created in the second ANF ONTAP cluster 2808b. As used herein, a clone volume is a writable, point-in-time copy of a parent volume. The clone of the volume may be created by issuing a volume clone command that specifies the volume in the backup snapshot. In an embodiment, an API is used to create the volume clone. As an example, an API called “create volume” in Azure management repository may be used. This step may be repeated when there are multiple volumes in the backup snapshot.

Next, at step 3006, the datastore supported by the volume clone is mounted in the secondary AVS with ANF cloud service 104-6 so that the datastore can be accessed and used to store data. In an embodiment, an API is used to mount the datastore. As an example, an API called “create datastore” in Azure management repository may be used.

Next, at step 3008, the mounting datastore operation, which may be an asynchronous job, is tracked. The purpose of this step is to monitor the progress and status of the mounting datastore job. This step ensures that the datastore is mounted successfully and addresses any issues that may arise. In an embodiment, an API is used to track the mounting datastore operation. As an example, an API called “get operationresults” in Azure management repository may be used.

Next, at step 3010, the VMs in the datastore are registered with the vCenter module 2804b in the second AVS with ANF cloud service 104-6, which completes the test failover. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

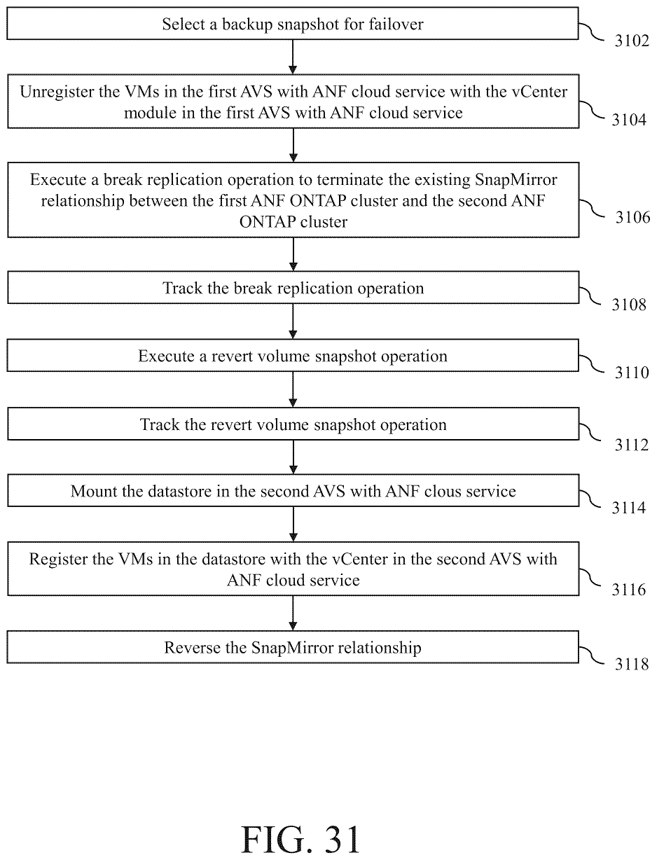

Turning now to FIG. 31, a flow diagram of a process of executing a failover from the first AVS with ANF cloud service 102 to the second AVS with ANF cloud service 104-6 in accordance with an embodiment of the disclosure is shown. This process is described with references to FIG. 28.

The process begins at step 3102, where a backup snapshot is selected for failover by the cloud-based disaster recovery service 130. In an embodiment, an administrator may use the UI for the cloud-based disaster recovery service to manually enter the backup snapshot for the failover for a selected disaster recovery plan.

Next, at step 3104, the VMs in the first AVS with ANF cloud service 102 are unregistered with the vCenter module 2804a in the first AVS with ANF cloud service. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

Next, at step 3106, a break replication operation is executed to terminate the SnapMirror relationship between the first ANF ONTAP cluster 2808a and the second ANF ONTAP cluster 2808b. This step is executed with the force break replication option, which ignores any transfer in progress during the break replication. In an embodiment, an API is used to execute the break replication operation. As an example, an API called “break replication” in Azure management repository may be used.

Next, at step 3108, the break replication operation is tracked. The purpose of this step is to monitor the progress and status of the break replication job. This step ensures that the replication break is completed successfully and addresses any issues that may arise. In an embodiment, an API is used to track the break replication operation. As an example, an API called “get operationresults” in Azure management repository may be used.

Next, at step 3110, a revert volume snapshot operation is executed. The purpose of this step is to revert the destination volume to the selected snapshot from the cloud-based disaster recovery service 130. This step ensures that the target volume reflects the state of the selected snapshot. In an embodiment, an API is used to execute the revert volume snapshot operation. As an example, an API called “revert volume” in Azure management repository may be used.

Next, at step 3112, the revert volume snapshot operation, which may be an asynchronous job, is tracked. The purpose of this step is to monitor the progress and status of the revert volume snapshot job. This step ensures that the revert operation is completed successfully and addresses any issues that may arise. In an embodiment, an API is used to track the revert volume snapshot operation. As an example, an API called “get operationresults” in Azure management repository may be used.

Next, at step 3114, the datastore is mounted in the second AVS with ANF cloud service 104-6. The purpose of this step is to connect the reverted ANF volumes to the second AVS with ANF cloud service 104-6 as datastores. In an embodiment, an API is used to mount the datastore in the second AVS with ANF cloud service. As an example, an API called “create datastore” in Azure management repository may be used.

Next, at step 3116, the VMs in the datastore are registered with the vCenter module 2804b running in the second AVS with ANF cloud service 104-6. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 3118, the SnapMirror relationship is reversed so that the previous source volume in the first AVS with ANF cloud service 102 is now the destination volume for replication and the previous destination volume in the second AVS with ANF cloud service 104-6 is now the source volume for replication. This process may be executed by creating a new SnapMirror relationship between the first ANF ONTAP cluster and the second ANF ONTAP cluster to replicate data from the second ANF ONTAP cluster to the first ANF ONTAP cluster using ANF Cross Region Replication. In an embodiment, an API is used to reverse the SnapMirror relationship. As an example, an API called “create replication” in Azure management repository may be used.

Once the VMs have been registered, the VMs in the first AVS with ANF cloud service 102 have been migrated to the second AVS with ANF cloud service 104-6 using the backup snapshot. However, in order to complete the failover process, the SnapMirror relationship is reversed so that the first AVS with ANF cloud service can be used for future failover.

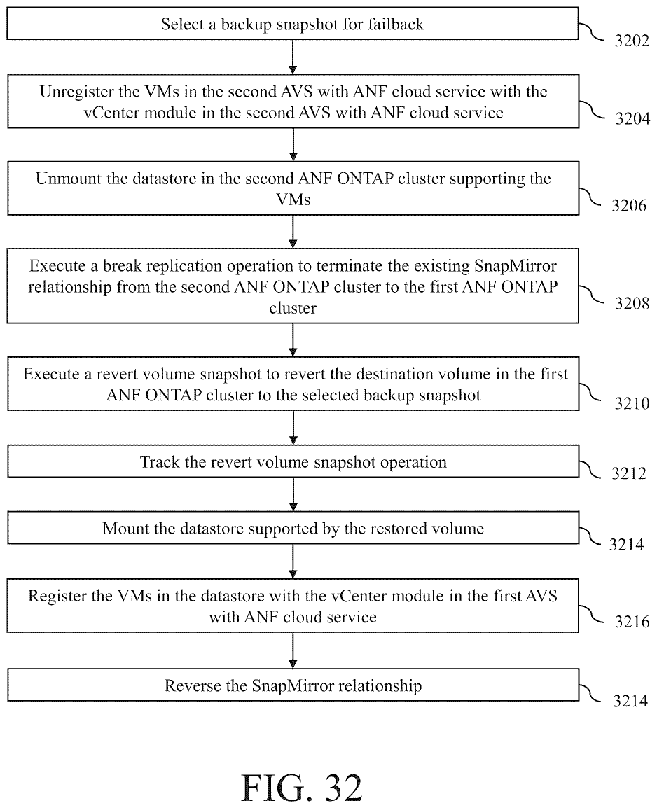

Turning now to FIG. 32, a flow diagram of a process of executing a failback from the second AVS with ANF cloud service 104-6 to the first AVS with ANF cloud service 102 in accordance with an embodiment of the disclosure is shown. This process is described with references to FIG. 28.

The process begins at step 3202, where a backup snapshot is selected for failback by the cloud-based disaster recovery service 130. In an embodiment, an administrator may use the UI for the cloud-based disaster recovery service to manually enter the backup snapshot for the failback for a selected disaster recovery plan.

Next, at step 3204, the VMs in the second AVS with ANF cloud service 104-6 are unregistered with the vCenter module 2804b in the second AVS with ANF cloud service. In an embodiment, one or more APIs or scripts may be used to unregister the VMs. For example, one or more automation scripts or tools using Go library for VMware vSphere APIs may be used to unregister the VMs. As an example, an automation script called “unregister” may be used to unregister the VMs.

At step 3206, the datastore in the second ANF ONTAP cluster 2808b supporting the VMs is unmounted so that the datastore can no longer be accessed and used to store data. In an embodiment, an API is used to unmount the datastore. As an example, an API called “delete datastore” in Azure management repository may be used.

Next, at step 3208, a break replication operation is executed to terminate the existing SnapMirror relationship from the second ANF ONTAP cluster 2808b to the first ANF ONTAP cluster 2808a. In an embodiment, an API is used to execute the break replication operation. As an example, an API called “break replication” in Azure management repository may be used.

Next, at step 3210, a revert volume snapshot operation is executed to revert the destination volume in the first ANF ONTAP cluster 2808a to the selected backup snapshot. This step ensures that the target volume reflects the state of the selected snapshot. In an embodiment, an API is used to execute the revert volume snapshot operation. As an example, an API called “revert volume” in Azure management repository may be used.

Next, at step 3212, the revert volume snapshot operation, which may be an asynchronous job, is tracked. The purpose of this step is to monitor the progress and status of the revert volume snapshot job. This step ensures that the revert operation is completed successfully and addresses any issues that may arise. In an embodiment, an API is used to track the revert volume snapshot operation. As an example, an API called “get operationresults” in Azure management repository may be used.

Next, at step 3214, the datastore supported by the restored volume in the first ANF ONTAP cluster 2808a is mounted so that the datastore can be accessed and used to store data. In an embodiment, an API is used to mount the datastore. As an example, an API called “create datastore” in Azure management repository may be used.

Next, at step 3216, the VMs in the datastore are registered with the vCenter module 2804a in the first AVS with ANF cloud service 102. In an embodiment, one or more APIs or scripts may be used to register the VMs. For example, one or more automation scripts or tools using Go library for VMware vSphere APIs may be used to register the VMs. As an example, an automation script called “registerVM” may be used to register the VMs.

Next, at step 3218, the SnapMirror relationship is reversed so that the previous source volume in the second AVS with ANF cloud service 104-6 is now the destination volume for replication and the previous destination volume in the first AVS with ANF cloud service 102 is now the source volume for replication. This process may be executed by creating a new SnapMirror relationship between the first ANF ONTAP cluster and the second ANF ONTAP cluster to replicate data from the first ANF ONTAP cluster to the second ANF ONTAP cluster using ANF Cross Region Replication. In an embodiment, an API is used to reverse the SnapMirror relationship. As an example, an API called “create replication” in Azure management repository may be used.

In some embodiments, the cloud-to-cloud disaster recovery may be implemented between other cloud services. For example, disaster recovery may be implemented between two EVS with FSxN cloud services in different AWS regions, between two VMC on AWS with FSxN cloud services in different AWS regions, or between two AVS with CVO cloud services in different Azure regions. The disaster recovery operations for these cloud-to-cloud configurations may follow similar processes as described above, with appropriate modifications for the specific cloud platform and storage service being used.

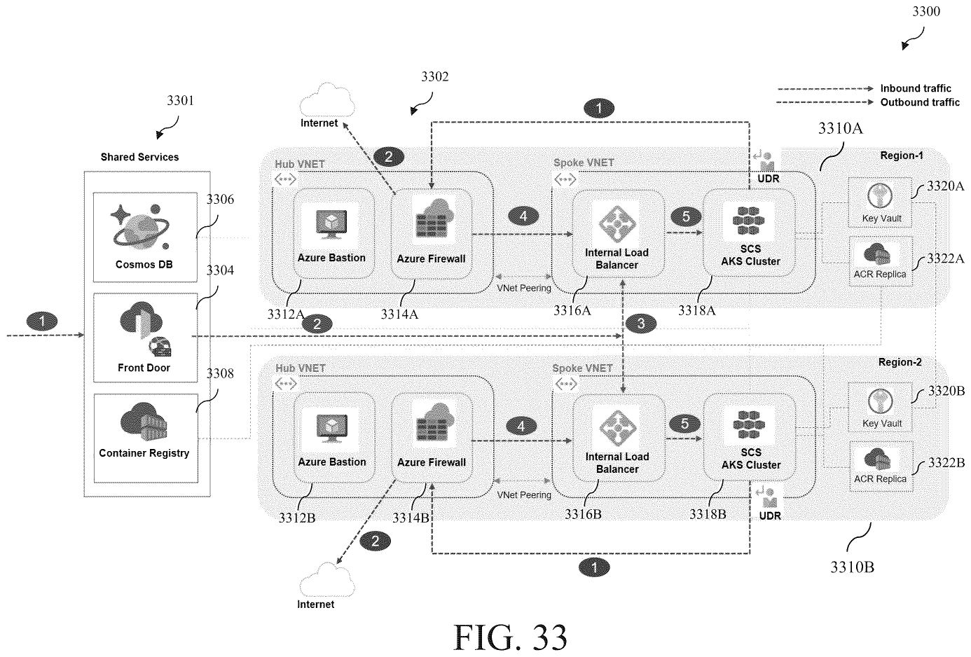

Turning now to FIG. 33, a multi-region deployment architecture 3300 for a cloud-based disaster recovery service 130 in accordance with an embodiment of the disclosure is illustrated. The multi-region deployment architecture 3300 includes a shared services layer 3301 and a plurality 3302 of regions that together provide availability and redundancy for the cloud-based disaster recovery service 130.

The shared services layer 3301 includes a global traffic management service 3304, e.g., an Azure front door, a distributed database service 3306, e.g., a Cosmos DB, and a container registry service 3308, e.g., an Azure container registry. The global traffic management service 3304 is positioned to receive inbound requests and route the requests to one of the regions. The distributed database service 3306 provides persistent data storage accessible across regions. The container registry service 3308 stores container images used by workloads deployed in the regions.

The multi-region deployment architecture 3300 further includes a primary region 3310A and a secondary region 3310B. The primary region 3310A and the secondary region 3310B may be geographically separated cloud regions.

The primary region 3310A includes a regional network environment comprising a bastion service 3312A, e.g., an Azure bastion, a firewall service 3314A, e.g., an Azure firewall, and an internal load balancer 3316A. The bastion service 3312A enables secure administrative access to internal resources, the firewall service 3314A controls inbound and outbound network traffic, and the internal load balancer 3316A distributes traffic to backend workloads within the primary region 3310A.

The primary region 3310A further includes a container orchestration cluster 3318A hosting an Azure Kubernetes Service (AKS) cluster that executes components of the cloud-based disaster recovery service 130. The container orchestration cluster 3318A is communicatively coupled to a key vault 3320A for secure storage of secrets and credentials and to a container registry replica 3322A, e.g., an Azure container registry (ACR) replica, that provides region-local access to container images.

The secondary region 3310B includes corresponding regional components, including a bastion service 3312B, a firewall service 3314B, and an internal load balancer 3316B. The bastion service 3312B enables secure administrative access, the firewall service 3314B controls network traffic, and the internal load balancer 3316B distributes traffic within the secondary region 3310B.

The secondary region 3310B further includes a container orchestration cluster 3318B hosting an SCS AKS cluster that executes components of the cloud-based disaster recovery service 130. The container orchestration cluster 3318B is communicatively coupled to a key vault 3320B and to a container registry replica 3322B.

In the illustrated embodiment, in each region, the bastion service and the firewall service may be in a hub virtual network (VNET) and the internal load balancer and the container orchestration cluster may be in a spoke VNET. The hub VNET and the spoke VNET in the same region may be VNET peered.

In the illustrated embodiment, inbound requests are received by the global traffic management service 3304 and routed to either the primary region 3310A or the secondary region 3310B using Azure user-defined routes (UDRs). Within a selected region, traffic is processed through the firewall service and internal load balancer before reaching the container orchestration cluster.

The multi-region deployment architecture 3300 shown in FIG. 33 provides regional redundancy for the cloud-based disaster recovery service 130 by deploying corresponding regional components in the primary region 3310A and the secondary region 3310B and by utilizing the shared services layer to support request routing, data storage, and container image distribution.

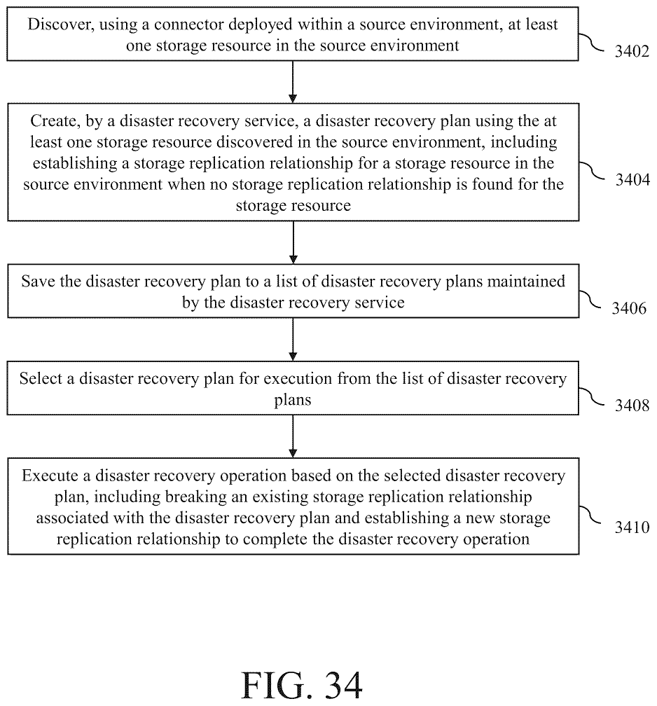

Turning now to FIG. 34, a process flow diagram of a method executed by one or more processors in accordance with an embodiment of the disclosure is shown. At block 3402, at least one storage resource in the source environment are discovered using a connected deployed within a source environment. At block 3404, a disaster recovery plan is created by a disaster recovery service using the at least one storage resource discovered in the source environment. This step includes establishing a storage replication relationship for a storage resource in the source environment when no storage replication relationship is found for the storage resource. At block 3406, the disaster recovery plan is saved to a list of disaster recovery plans maintained by the disaster recovery service. At block 3408, a disaster recovery plan is selected for execution from the list of disaster recovery plans. At block 3410, a disaster recovery operation is executed based on the selected disaster recovery plan. This step includes breaking an existing storage replication relationship associated with the disaster recovery plan and establishing a new storage replication relationship to complete the disaster recovery operation.

In an embodiment, the disaster recovery solution described herein can provide datastore and VM-based protection with VM and application consistent backups. In addition, the disaster recovery solution can support multiple protocols (e.g., NFS, VMFS and FC) and multiple clouds (e.g., Azure and AWS). The disaster recovery solution can also support multiple versions of ONTAP, including ASA r2, with ONTAP consistency group (CG) integration. The disaster recovery solution can support

The disaster recovery solution can also provide VM customizations, such as boot order (power on sequence of VMs in a functional resource group), boot delay for each VM (to enable a sequence for VMs to start), VM aliasing (assign a different name to the VM in the failover site) and destination VM's moved to folder.

The disaster recovery solution can also provide resource groups, which allows grouping of resources, such as VMs or datastores. Resource groups enables an administrator to organize a set of dependent VMs into logical groups that meet prescribed requirements. For example, an administrator might group VMs associated with one application or group applications that have similar tiers. As another example, groups could contain delayed boot orders that can be run upon recovery.

The disaster recovery solution can also provide role-based access control (RBAC), such as BlueXP RBAC. The disaster recovery solution can also provide a proxy for the vCenter module or storage. The disaster recovery solution can also provide a schedule for various operations, such as compliance, discovery, backup and/or test failover.

The disaster recovery solution can also provide platform-based snapshot, such as snapshots of external snapshot management solutions, for example, the native ONTAP SnapMirror policy scheduler or third-party integrations with ONTAP.

The disaster recovery solution can also provide network customization, such as network selection for test failover and failover, as well as network customization for cluster, vCenter module, ESX and datastore.

The disaster recovery solution can also provide subnet mapping. As an example, an administer can manage IP addresses on failover in a new way using subnet mapping, which enables one to add subnets for each vCenter module. When one does so, one defines the IPv4 CIDR, the default gateway, and the DNS for each virtual network. Upon failover, the cloud-based disaster recovery service 130 can determine the appropriate IP address of each vNIC by looking at the CIDR provided for the mapped virtual network and uses it to derive the new IP address. In addition, the disaster recovery solution may provide an Add and Edit Subnet Mapping dialog with a new search functionality so that one can quickly find specific subnets by entering search terms, making it easier to manage subnet mappings.

The disaster recovery solution can also support Local Administrator Password Solution (LAPS). Windows Local Administrator Password Solution (Windows LAPS) is a Windows feature that automatically manages and backs up the password of a local administrator account on Active directory. In an embodiment, an administer can select subnet mapping options and check the LAPS option by providing the domain controller details. Using this option, one does not need to provide a password for each of one's virtual machines.

The disaster recovery solution can also support script execution. In addition, the disaster recovery solution can also provide skip protection, which allows failover without protection (same as migration). Thus, one can skip protection so that the cloud-based disaster recovery service 130 does not automatically create a reverse protection relationship after a replication plan failover. This is useful if one wants to perform additional operations on the restored site before one bring it back online. When one initiates a failover, by default the service may automatically create a reverse protection relationship for each volume in the replication plan, if the original source site is online. This means that the service creates a SnapMirror relationship from the target site back to the source site. The service also automatically reverses the SnapMirror relationship when one initiates a failback. When initiating a failover, one can choose a skip protection option. With this, the service does not automatically reverse the SnapMirror relationship. Instead, it leaves the writable volume on both sides of the replication plan. After the original source site is back online, one can establish reverse protection by selecting protect resources from a Replication plan Actions menu. This attempts to create a reverse replication relationship for each volume in the plan. One can run this job repeatedly until protection is restored. When protection is restored, one can initiate a failback in the usual way.

The disaster recovery solution can also provide force failover, which is manually initiated regardless of the state of any replication plan.

The disaster recovery solution can also provide scalability to support an increasing number of protected workloads, storage resources and recovery sites by dynamically discovering resources, managing multiple replication relationships and orchestrating concurrent disaster recovery operations across hybrid and cloud computing environments.

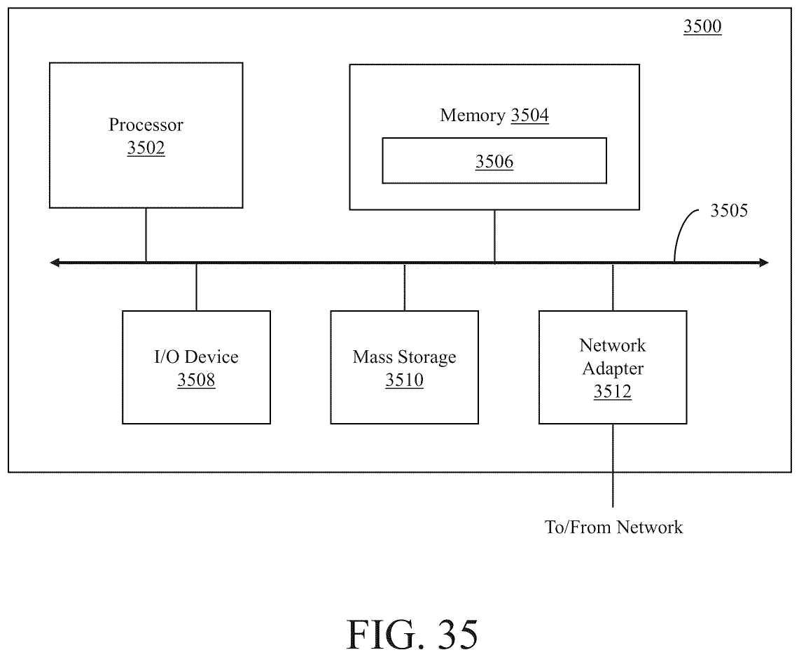

FIG. 35 is a high-level block diagram showing an example of the architecture of a processing system 3500 in accordance with an embodiment of the disclosure, in which executable instructions for operations as described above can be implemented. The processing system 3500 can represent one or more components in the distributed computing system 100 described herein. Note that certain standard and well-known components which are not germane to the present disclosure are not shown in FIG. 35.

The processing system 3500 includes one or more processors 3502 and memory 3504, coupled to a bus system 3505. The bus system 3505 shown in FIG. 35 is an abstraction that represents any one or more separate physical buses and/or point-to-point connections, connected by appropriate bridges, adapters and/or controllers. The bus system 3505, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 3502 are the central processing units (CPUs) of the processing system 3500 and, thus, control its overall operation. In certain aspects, the processors 3502 accomplish this by executing programmable instructions stored in the memory 3504. Each processor 3502 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 3504 represents any form of random-access memory (RAM), read-only memory (ROM), flash memory, or the like, or a combination of such devices. The memory 3504 includes the main memory of the processing system 3500. Instructions 3506 which implement techniques introduced above may reside in and may be executed by the processors 3502 from the memory 3504. For example, the instructions 3506 may include code used for executing at least some of steps of methods or operations described herein, as well running various applications/processes running in the distributed computing system 100.

Also connected to the processors 3502 through the bus system 3505 are one or more internal mass storage devices 3510, and a network adapter 3512. The internal mass storage devices 3510 may be or may include any conventional medium for storing large volumes of data in a non-volatile manner, such as one or more magnetic or optical based disks. The network adapter 3512 provides the processing system 3500 with the ability to communicate with remote devices (e.g., storage servers) over a network and may be, for example, an Ethernet adapter, a Fibre Connector (FC) adapter, or the like. The processing system 3500 also includes one or more input/output (I/O) devices 3508 coupled to the bus system 3505. The I/O devices 3508 may include, for example, a display device, a keyboard, a mouse, etc.

Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

Similarly, reference throughout this specification to “one embodiment,” “an embodiment,” or similar language means that a particular feature, structure, or characteristic described in connection with the indicated embodiment is included in at least one embodiment of the present disclosure. Thus, the phrases “in one embodiment,” “in an embodiment,” and similar language throughout this specification may, but do not necessarily, all refer to the same embodiment.

While the present disclosure is described above with respect to what is currently considered its preferred aspects, it is to be understood that the disclosure is not limited to that described above. To the contrary, the disclosure is intended to cover various modifications and equivalent arrangements.

What is claimed is:

1. A method executed by one or more processors, comprising:
discovering, using a connector deployed within a source environment, at least one storage resource in the source environment;
creating, by a disaster recovery service, a disaster recovery plan using the at least one storage resource discovered in the source environment, including establishing a storage replication relationship for a storage resource in the source environment when no storage replication relationship is found for the storage resource;
saving the disaster recovery plan to a list of disaster recovery plans maintained by the disaster recovery service;
selecting a disaster recovery plan for execution from the list of disaster recovery plans; and
executing a disaster recovery operation based on the selected disaster recovery plan, including breaking an existing storage replication relationship associated with the disaster recovery plan and establishing a new storage replication relationship to complete the disaster recovery operation.

2. The method of claim 1, wherein the source environment is an on-premises computing system or a public cloud service.

3. The method of claim 1, wherein the disaster recovery operation is a failover operation, a failback operation, or a test failover operation.

4. The method of claim 1, wherein discovering the at least one storage resource includes retrieving datastore and storage footprint details, work environment details, and storage virtual machine details from the source environment.

5. The method of claim 1, wherein creating the disaster recovery plan further includes:
performing a discovery operation on a destination environment to retrieve storage resource details of the destination environment;
establishing a cluster peering between a storage cluster in the source environment and a storage cluster in the destination environment; and
establishing a storage virtual machine peering between a storage virtual machine in the source environment and a storage virtual machine in the destination environment.

6. The method of claim 5, wherein the destination environment is an on-premises computing system or a public cloud service.

7. The method of claim 1, wherein the storage replication relationship is a snapshot-based storage replication relationship.

8. The method of claim 1, wherein executing the disaster recovery operation further includes:
selecting a backup snapshot for the disaster recovery operation;
restoring the backup snapshot in a destination environment; and
registering one or more virtual machines associated with the restored backup snapshot with a cluster management center in the destination environment.

9. The method of claim 8, wherein executing the disaster recovery operation further includes:
unregistering the one or more virtual machines with a cluster management center in the source environment prior to restoring the backup snapshot in the destination environment.

10. The method of claim 8, wherein executing the disaster recovery operation further includes:
mounting a datastore supported by a restored volume in the destination environment prior to registering the one or more virtual machines.

11. The method of claim 1, wherein the disaster recovery operation is a test failover operation, and wherein executing the disaster recovery operation includes:
selecting a backup snapshot for the test failover operation;
creating a clone of a volume in the backup snapshot in a destination environment;
mounting a datastore supported by the clone of the volume; and
registering one or more virtual machines in the datastore with a cluster management center in the destination environment.

12. The method of claim 1, wherein establishing the new storage replication relationship includes reversing a direction of replication so that a previous source volume becomes a destination volume and a previous destination volume becomes a source volume.

13. The method of claim 1, further comprising:
creating a backup snapshot of one or more volumes in the source environment; and
replicating the backup snapshot to a destination environment using the storage replication relationship.

14. A non-transitory computer-readable storage medium containing program instructions, wherein execution of the program instructions by one or more processors of a computer causes the one or more processors to perform steps comprising:
discovering, using a connector deployed within a source environment, at least one storage resource in the source environment;
creating, by a disaster recovery service, a disaster recovery plan using the at least one storage resource discovered in the source environment, including establishing a storage replication relationship for a storage resource in the source environment when no storage replication relationship is found for the storage resource;
saving the disaster recovery plan to a list of disaster recovery plans maintained by the disaster recovery service;
selecting a disaster recovery plan for execution from the list of disaster recovery plans; and
executing a disaster recovery operation based on the selected disaster recovery plan, including breaking an existing storage replication relationship associated with the disaster recovery plan and establishing a new storage replication relationship to complete the disaster recovery operation.

15. The non-transitory computer-readable medium of claim 14, wherein the source environment is an on-premises computing system or a public cloud service.

16. The non-transitory computer-readable medium of claim 14, wherein the disaster recovery operation is a failover operation, a failback operation, or a test failover operation.

17. The non-transitory computer-readable medium of claim 14, wherein creating the disaster recovery plan further includes:
performing a discovery operation on a destination environment to retrieve storage resource details of the destination environment;
establishing a cluster peering between a storage cluster in the source environment and a storage cluster in the destination environment; and
establishing a storage virtual machine peering between a storage virtual machine in the source environment and a storage virtual machine in the destination environment.

18. The non-transitory computer-readable medium of claim 14, wherein the storage replication relationship is a snapshot-based storage replication relationship.

19. The non-transitory computer-readable medium of claim 14, wherein executing the disaster recovery operation further includes:
selecting a backup snapshot for the disaster recovery operation;
restoring the backup snapshot in a destination environment; and
registering one or more virtual machines associated with the restored backup snapshot with a cluster management center in the destination environment.

20. A system comprising:
memory; and
at least one processor configured to:
discover, using a connector deployed within a source environment, at least one storage resource in the source environment;
create a disaster recovery plan using the at least one storage resource discovered in the source environment, including establishing a storage replication relationship for a storage resource in the source environment when no storage replication relationship is found for the storage resource;
save the disaster recovery plan to a list of disaster recovery plans;
select a disaster recovery plan for execution from the list of disaster recovery plans; and
execute a disaster recovery operation based on the selected disaster recovery plan, including breaking an existing storage replication relationship associated with the disaster recovery plan and establishing a new storage replication relationship to complete the disaster recovery operation.
